(19) United States
(12) Patent Application Publication
(10) Pub. No.: US 2025/0239217 A1
(43) Pub. Date: Jul. 24, 2025

(54) DISPLAY PANEL AND DISPLAY DEVICE

(71) Applicants: Wuhan Tianma Microelectronics Co., Ltd., Wuhan (CN); Wuhan Tianma Microelectronics Co., Ltd. Shanghai Branch, Pudong New District, Shanghai (CN)

(72) Inventors: Yana GAO, Wuhan (CN); Xingyao ZHOU, Wuhan (CN); Gaojun HUANG, Wuhan (CN)

(21) Appl. No.: 19/174,886

(22) Filed: Apr. 9, 2025

(30) Foreign Application Priority Data
Apr. 28, 2024 (CN) 202410525463.3

(51) Int. Cl. G09G 3/32

(52) U.S. Cl. CPC G09G 3/32; G09G 2300/0842; G09G 2320/0233; G09G 2320/0247

(57) ABSTRACT

A display panel and a display device. A pixel driver circuit includes a drive transistor, a light-emitting control transistor, and a transmission transistor. A light-emitting control scanning signal line is connected to a gate of the light-emitting control transistor and includes a first connection line. A second connection line includes a first end electrically connected to a first electrode of the drive transistor and a second end electrically connected to a first electrode of the transmission transistor. The light-emitting control transistor includes a first electrode electrically connected to a second electrode of the drive transistor and a second electrode electrically connected to a first electrode portion of a light-emitting element. A shielding component is configured to receive a direct current voltage signal. The shielding component is located between the first and second connection lines; and the shielding component, and the first and second connection lines overlap with each other.

### CROSS-REFERENCE TO RELATED APPLICATIONS

The present application claims priority to Chinese Patent Application No. 202410525463.3 filed on Apr. 28, 2024, the content of which is incorporated herein by reference in its entirety.

### TECHNICAL FIELD

The present disclosure relates to the field of display technologies, and in particular, to a display panel and a display device.

### BACKGROUND

Increasingly high requirements for display technologies result in growing display requirements for display panels.

However, if a pixel driver circuit in a display panel has improper wiring, when the pixel driver circuit works in a low-frequency mode to drive a light-emitting element to perform black-state display, it is highly likely that the display panel is not black in a black state. This deteriorates display quality of the display panel.

### SUMMARY

The present disclosure provides a display panel and a display device to resolve a problem in the related art that a display panel is not black in a black state when a pixel driver circuit works in a low-frequency mode to drive a light-emitting element to perform black-state display, to improve display quality of the display panel.

In an aspect, an embodiment of the present disclosure provides a display panel, including: a substrate; a light-emitting element including a first electrode portion, a light-emitting layer, and a second electrode portion; a pixel driver circuit located at a side of the substrate and including a drive transistor, a light-emitting control transistor, and a transmission transistor; a light-emitting control scanning signal line extending in a first direction, connected to a gate of the light-emitting control transistor, and including a first connection line; a second connection line including a first end electrically connected to a first electrode of the drive transistor and a second end electrically connected to a first electrode of the transmission transistor, the light-emitting control transistor including a first electrode electrically connected to a second electrode of the drive transistor and a second electrode electrically connected to the first electrode portion of the light-emitting element; and a shielding component configured to receive a direct current voltage signal. In a direction perpendicular to a plane of the substrate, the shielding component is located between the first connection line and the second connection line, and the shielding component, the first connection line, and the second connection line overlap with each other.

In another aspect, an embodiment of the present disclosure provides a display device, including a display panel. The display panel includes: a substrate; a light-emitting element including a first electrode portion, a light-emitting layer, and a second electrode portion; a pixel driver circuit located at a side of the substrate and including a drive transistor, a light-emitting control transistor, and a transmission transistor; a light-emitting control scanning signal line extending in a first direction, connected to a gate of the light-emitting control transistor, and including a first connection line; a second connection line including a first end electrically connected to a first electrode of the drive transistor and a second end electrically connected to a first electrode of the transmission transistor, the light-emitting control transistor including a first electrode electrically connected to a second electrode of the drive transistor and a second electrode electrically connected to the first electrode portion of the light-emitting element; and a shielding component configured to receive a direct current voltage signal. In a direction perpendicular to a plane of the substrate, the shielding component is located between the first connection line and the second connection line, and the shielding component, the first connection line, and the second connection line overlap with each other.

### BRIEF DESCRIPTION OF DRAWINGS

In order to better illustrate technical solutions in embodiments of the present disclosure or in the related art, the accompanying drawings used in the embodiments and in the related art are briefly introduced as follows. It should be noted that the drawings described as follows are merely part of the embodiments of the present disclosure, and those skilled in the art may expand and extend to other structures and accompanying drawings based on basic concepts of a device structure, a driving method, and a manufacturing method disclosed and suggested in various embodiments of the present disclosure. Undoubtedly, these shall fall within a scope of the present disclosure.

FIG. 1 is a schematic diagram of an element structure of a pixel driver circuit in the related art;

FIG. 2 is a schematic diagram of a film layer structure of the pixel driver circuit in the related art shown in FIG. 1;

FIG. 3 is a structural schematic diagram of a display panel according to an embodiment of the present disclosure;

FIG. 4 is a schematic diagram of an element structure of a pixel driver circuit according to an embodiment of the present disclosure;

FIG. 5 is a schematic diagram of a film layer structure of the pixel driver circuit shown in FIG. 4;

FIG. 6 is a structural schematic diagram of a cross section in FIG. 5;

FIG. 7 is another schematic diagram of an element structure of a pixel driver circuit according to an embodiment of the present disclosure;

FIG. 8 is a schematic diagram of a film layer structure of the pixel driver circuit shown in FIG. 7;

FIG. 8A is a structural schematic diagram of a light-shielding metal layer in FIG. 8;

FIG. 8B is a structural schematic diagram of a first semiconductor layer in FIG. 8;

FIG. 8C is a structural schematic diagram of a first metal layer in FIG. 8;

FIG. 8D is a structural schematic diagram of a second metal layer in FIG. 8;

FIG. 8E is a structural schematic diagram of a second semiconductor layer in FIG. 8;

FIG. 8F is a structural schematic diagram of a fourth metal layer in FIG. 8;

FIG. 8G is a structural schematic diagram of a third metal layer in FIG. 8;

FIG. 8H is a structural schematic diagram of a fifth metal layer in FIG. 8;

FIG. 8I is a structural schematic diagram of a sixth metal layer in FIG. 8;

FIG. 9 is a structural schematic diagram of a cross section in FIG. 8;

FIG. 10 is a schematic diagram of a partial film layer structure in FIG. 8;

FIG. 11 is another schematic diagram of a partial film layer structure in FIG. 8;

FIG. 12 is a schematic diagram of a cross section of a partial film layer structure in FIG. 11;

FIG. 13 is a partial schematic diagram of a partial film layer structure of the pixel driver circuit shown in FIG. 7;

FIG. 14 is another partial schematic diagram of a partial film layer structure of the pixel driver circuit shown in FIG. 7;

FIG. 15 is another partial schematic diagram of a partial film layer structure of the pixel driver circuit shown in FIG. 7;

FIG. 16 is another partial schematic diagram of a partial film layer structure of the pixel driver circuit shown in FIG. 7;

FIG. 17 is another schematic diagram of a partial film layer structure of the pixel driver circuit shown in FIG. 7;

FIG. 18 is another schematic diagram of a partial film layer structure of the pixel driver circuit shown in FIG. 7;

FIG. 19 is another partial schematic diagram of a partial film layer structure of the pixel driver circuit shown in FIG. 7;

FIG. 20 is another schematic diagram of a partial film layer structure of the pixel driver circuit shown in FIG. 7;

FIG. 21 is another partial schematic diagram of a partial film layer structure of the pixel driver circuit shown in FIG. 7;

FIG. 21A is a partially enlarged schematic diagram of a partial film layer structure in FIG. 21;

FIG. 22 is a partial schematic diagram of a structure of a display panel according to an embodiment of the present disclosure; and

FIG. 23 is a structural schematic diagram of a display device according to an embodiment of the present disclosure.

### DESCRIPTION OF EMBODIMENTS

To better illustrate the objectives, technical solutions, and advantages of the present disclosure, the technical solutions of the present disclosure will be described below with reference to the accompanying drawings in the embodiments of the present disclosure. Apparently, the described embodiments are merely some of, rather than all of the embodiments of the present disclosure. All other embodiments obtained by those skilled in the art based on basic concepts disclosed and suggested in the embodiments of the present disclosure shall fall within the protection scope of the present disclosure.

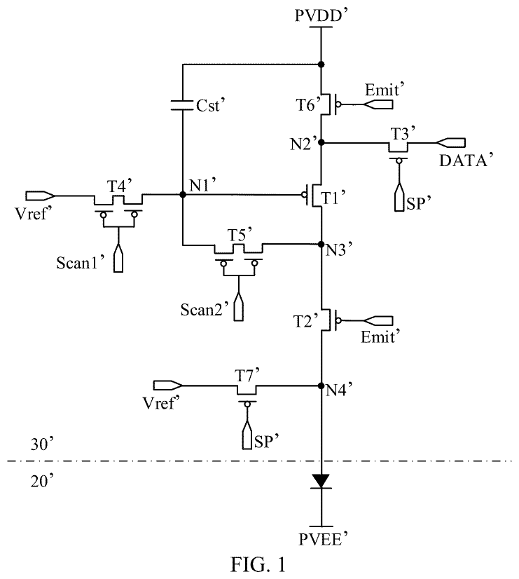

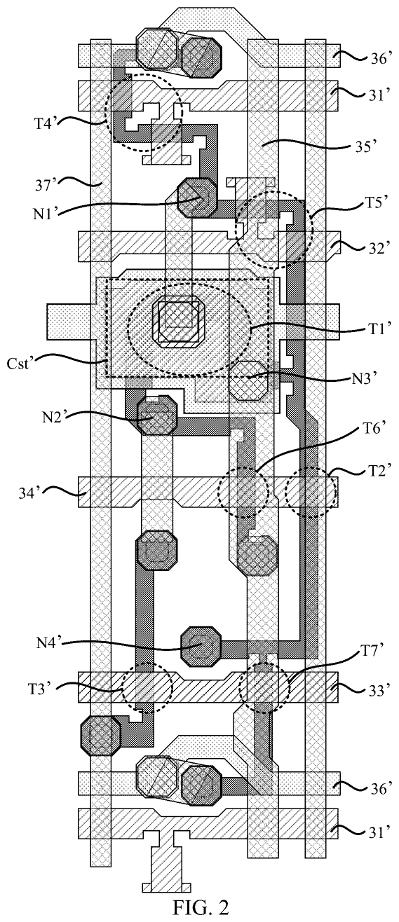

FIG. 1 is a schematic diagram of an element structure of a pixel driver circuit in the related art. FIG. 2 is a schematic diagram of a film layer structure of the pixel driver circuit in the related art shown in FIG. 1. Referring to FIG. 1 and FIG. 2, for example, a pixel driver circuit 30′ has a 7T1C structure (that is, including 7 transistors T1′ to T7′ and a storage capacitor Cst′). A display panel may include a first scanning line 31′, a second scanning line 32′, a third scanning line 33′, a light-emitting control scanning signal line 34′, a first power signal line 35′, a reference voltage line 36′, and a data signal line 37′. The pixel driver circuit 30′ may include a drive transistor T1′, a first light-emitting control transistor T2′, a data writing transistor T3′, a first reset transistor T4′, a threshold compensation transistor T5′, a second light-emitting control transistor T6′, a second reset transistor T7′, and a storage capacitor Cst′. A gate of the drive transistor T1′, a first electrode of the threshold compensation transistor T5′, and a first electrode of the first reset transistor T4′ are electrically connected to a first node N1′. A first electrode of the drive transistor T1′ and a first electrode of the data writing transistor T3′ are electrically connected to a second node N2′. A second electrode of the drive transistor T1′ and a first electrode of the first light-emitting control transistor T2′ are electrically connected to a third node N3′. A second electrode of the first light-emitting control transistor T2′ and an anode of a light-emitting element 20′ are electrically connected to a fourth node N4′. A cathode of the light-emitting element 20′ is electrically connected to a second power signal line (not shown in FIG. 2) for receiving a negative voltage signal PVEE′.

A first scanning signal Scan1′ on the first scanning line 31′ controls the first reset transistor T4′ to be turned on or off. A second scanning signal Scan2′ on the second scanning line 32′ controls the threshold compensation transistor T5′ to be turned on or off. A third scanning signal SP′ on the third scanning line 33′ controls the data writing transistor T3′ and the second reset transistor T7′ to be turned on or off. A light-emitting control scanning signal Emit′ on the light-emitting control scanning signal line 34′ controls the first light-emitting control transistor T2′ and the second light-emitting control transistor T6′ to be turned on or off. The first power signal line 35′ provides a positive voltage signal PVDD′. The reference voltage line 36′ provides a reference voltage signal Vref. The data signal line 37′ provides a data signal DATA′.

Still referring to FIG. 1 and FIG. 2, because the third scanning signal SP′ on the third scanning line 33′ controls the data writing transistor T3′ and the second reset transistor T7′ to be turned on or off, and the light-emitting control scanning signal line 34′ is located between the data writing transistor T3′ and the second node N2′, the data writing transistor T3′ and the second node N2′ need to be connected to each other through a crossover line, which overlaps the light-emitting control scanning signal line 34′. However, when the light-emitting control scanning signal Emit′ on the light-emitting control scanning signal line 34′ jumps, the second node N2′ is coupled, resulting in impact on a potential of the second node N2′. Especially when the light-emitting control scanning signal Emit′ jumps from a low level to a high level, the potential of the second node N2′ is coupled and pulled up, and electric leakage occurs in a direction towards the third node N3′ and the fourth node N4′, leading to an increase in a potential of the fourth node N4′. When the pixel driver circuit 30′ works in a low-frequency mode and the light-emitting element 20′ is driven to perform black-state display, a black-state voltage significantly increases. Consequently, the display panel is not black in a black state, resulting in display non-uniformity of the display panel. This further deteriorates display quality of the entire display panel.

In view of the foregoing technical problem, the embodiments of the present disclosure provide a display panel, including a substrate, a light-emitting element, a pixel driver circuit, a light-emitting control scanning signal line, a second connection line. The light-emitting element includes a first electrode portion, a light-emitting layer, and a second electrode portion. The pixel driver circuit is located at a side of the substrate and includes a drive transistor, a light-emitting control transistor, and a transmission transistor. The light-emitting control scanning signal line extends in a first direction and is connected to a gate of the light-emitting control transistor. The light-emitting control scanning signal line includes a first connection line. The second connection line includes a first end electrically connected to a first electrode of the drive transistor and a second end electrically connected to a first electrode of the transmission transistor. The light-emitting control transistor includes a first electrode electrically connected to a second electrode of the drive transistor and a second electrode electrically connected to the first electrode portion of the light-emitting element. The display panel further includes a shielding component configured to receive a DC voltage signal, namely a fixed voltage signal. In a direction perpendicular to a plane of the substrate, the shielding component is located between the first connection line and the second connection line, and the shielding component, the first connection line, and the second connection line overlap with each other.

The transmission transistor may be a data writing transistor configured to write a data signal into the first electrode of the drive transistor, or a bias adjustment transistor configured to perform bias adjustment on a potential of the first electrode of the drive transistor. For example, this may be configured based on an actual pixel driver circuit.

In the foregoing technical solutions, the pixel driver circuit in the display panel includes the drive transistor, the light-emitting control transistor, and the transmission transistor; and the light-emitting control scanning signal line extends in the first direction and is connected to the gate of the light-emitting control transistor, such that a light-emitting control scanning signal on the light-emitting control scanning signal line can control the light-emitting control transistor to be turned on or off. The light-emitting control scanning signal line includes the first connection line. The first connection line may be disposed in a same layer as or a different layer from the light-emitting control scanning signal line. The second connection line includes a first end electrically connected to the first electrode of the drive transistor and a second end electrically connected to the first electrode of the transmission transistor. The light-emitting control transistor includes a first electrode electrically connected to the second electrode of the drive transistor and a second electrode electrically connected to the first electrode portion of the light-emitting element, such that a drive current generated by the drive transistor can be provided to the first electrode portion of the light-emitting element through the turned-on light-emitting control transistor, to drive the light-emitting element to emit light. The display panel further includes the shielding component configured to receive the DC voltage signal. In the direction perpendicular to the plane of the substrate, the shielding component is located between the first connection line and the second connection line, and the shielding component, the first connection line, and the second connection line overlap with each other. In this way, the shielding component can prevent the light-emitting control scanning signal on the light-emitting control scanning signal line from having coupling impact on the potential of the first electrode of the drive transistor. This resolves a problem in the related art that the display panel is not black in a black state when the pixel driver circuit works in a low-frequency mode to drive the light-emitting element to perform black-state display, thereby improving display uniformity, and thus improving display quality of the display panel.

The foregoing is a core idea of the present disclosure. The technical solutions in the embodiments of the present disclosure are described below with reference to the accompanying drawings in the embodiments of the present disclosure. Apparently, the described embodiments are merely some of, rather than all of the embodiments of the present disclosure. All other embodiments obtained by those of ordinary skill in the art based on the embodiments of the present disclosure without creative efforts shall fall within the protection scope of the present disclosure.

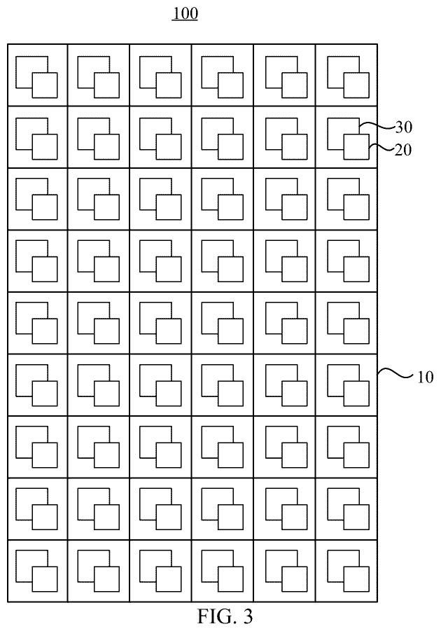

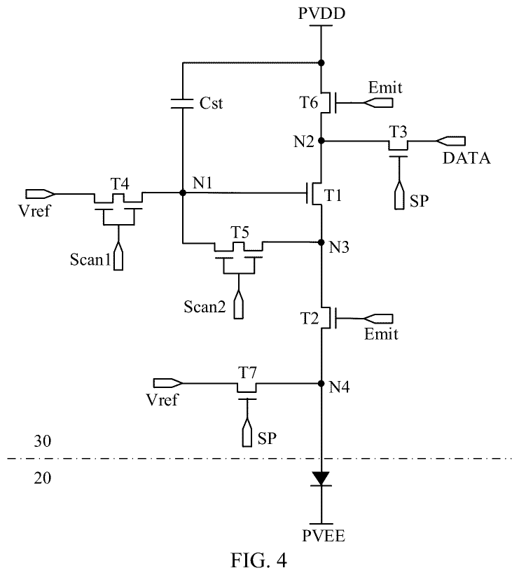

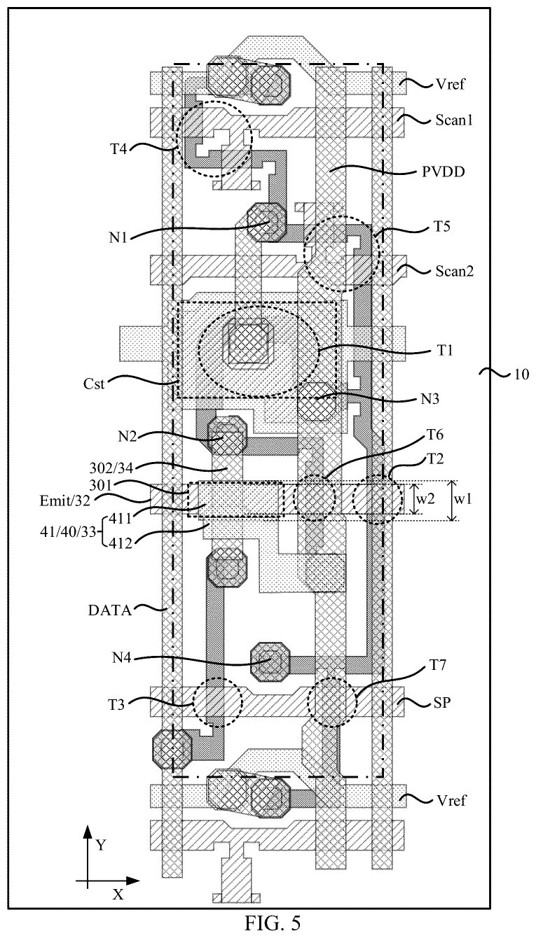

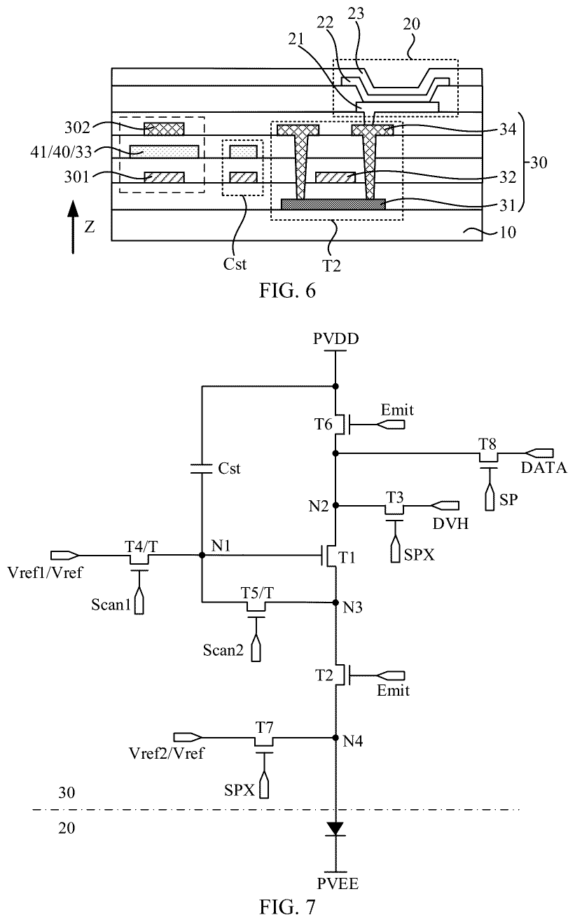

FIG. 3 is a structural schematic diagram of a display panel according to an embodiment of the present disclosure. FIG. 4 is a schematic diagram of an element structure of a pixel driver circuit according to an embodiment of the present disclosure. FIG. 5 is a schematic diagram of a film layer structure of the pixel driver circuit shown in FIG. 4. FIG. 6 is a structural schematic diagram of a cross section in FIG. 5. Referring to FIG. 3 to FIG. 6, a display panel 100 includes a substrate 10. A light-emitting element 20 includes a first electrode portion 21, a light-emitting layer 22, and a second electrode portion 23. A pixel driver circuit 30 is located at a side of the substrate 10, and the pixel driver circuit 30 includes a drive transistor T1, a light-emitting control transistor T2, and a transmission transistor T3. A light-emitting control scanning signal line Emit extends in a first direction X. The light-emitting control scanning signal line Emit is connected to a gate of the light-emitting control transistor T2, and includes a first connection line 301. A second connection line 302 includes a first end electrically connected to a first electrode of the drive transistor T1, and a second end electrically connected to a first electrode of the transmission transistor T3. The light-emitting control transistor T2 includes a first electrode electrically connected to a second electrode of the drive transistor T1, and a second electrode electrically connected to the first electrode portion 21. The display panel 100 further includes a shielding component 40. The shielding component 40 is configured to receive a DC voltage signal. In a direction (namely a Z direction) perpendicular to a plane of the substrate 10, the shielding component 40 is located between the first connection line 301 and the second connection line 302, and the shielding component 40, the first connection line 301, and the second connection line 302 overlap with each other.

It can be understood that a same-layer integral structure has an electrical connection relationship, and different-layer structures connected by an intermediate structure (for example, a conductive through-hole or another connection line) may have an electrical connection relationship. The electrical connection relationship may be a direct electrical connection relationship or an indirect electrical connection relationship, which is not limited herein.

The substrate 10 may be a rigid substrate. For example, the substrate 10 is made of glass. Alternatively, the substrate 10 may be a flexible substrate. For example, a material of the substrate 10 may include one or more of the following polymer resins: polyethersulfone, polyacrylate, polyetherimide, polyethylene naphthalate, polyethylene terephthalate, polyphenylene sulfide, polyarylate, polyimide, polycarbonate, and cellulose acetate propionate. The material of the substrate 10 is not limited herein.

Referring to FIG. 6, a film layer of the pixel driver circuit 30 is an array layer, which is located at a side of the substrate 10. The array layer may include a first semiconductor layer 31, a first metal layer 32, a second metal layer 33, and a third metal layer 34 that are stacked in sequence. FIG. 6 exemplarily shows a structure of the light-emitting control transistor T2 in the pixel driver circuit 30 and a structure of the light-emitting element 20. The first semiconductor layer 31 includes an active layer of the light-emitting control transistor T2. The first metal layer 32 may include the gate of the light-emitting control transistor T2. The second metal layer 33 may include a plate of a storage capacitor in the pixel driver circuit 30, a reference voltage line, or the like. The third metal layer 34 may include the first electrode and the second electrode, namely a source and a drain, of the light-emitting control transistor T2. The light-emitting element 20 includes the first electrode portion 21, the light-emitting layer 22, and the second electrode portion 23. The second electrode of the light-emitting control transistor T2 is electrically connected to the first electrode portion 21. In addition, an insulation layer is disposed between adjacent metal layers.

The light-emitting element 20 may be a light-emitting diode (LED), including but not limited to an organic LED (OLED), a mini LED, or a micro LED.

It should be noted that the light-emitting element 20 may further include an auxiliary light-emitting layer configured to promote recombination of a hole provided by the first electrode portion 21 (namely an anode) and an electron provided by the second electrode portion 23 (namely a cathode) in the light-emitting layer 22. For example, the auxiliary light-emitting layer may include one or more of a hole injection layer, a hole transport layer, an electron injection layer, and an electron transport layer, no limitation is made herein. For example, the light-emitting element 20 may include one or more of a red light-emitting element, a green light-emitting element, a blue light-emitting element, a white light-emitting element, a yellow light-emitting element, a cyan light-emitting element, and a magenta light-emitting element, which is not limited herein.

Referring to FIG. 4, a structure of the pixel driver circuit 30 may be configured based on an actual situation and is not limited herein. A gate of the drive transistor T1 is electrically connected to a first node N1. The first electrode of the drive transistor T1 and the first electrode of the transmission transistor T3 are electrically connected to a second node N2. The second electrode of the drive transistor T1 and the first electrode of the light-emitting control transistor T2 are electrically connected to a third node N3. The second electrode of the light-emitting control transistor T2 and the first electrode portion 21 of the light-emitting element 20 are electrically connected to a fourth node N4. The gate of the light-emitting control transistor T2 is electrically connected to the light-emitting control scanning signal line Emit, such that a light-emitting control scanning signal on the light-emitting control scanning signal line Emit can control the light-emitting control transistor T2 to be turned on or off.

In an embodiment, referring to FIG. 4, the transmission transistor T3 may be a data writing transistor configured to write a data signal into the gate of the drive transistor T1. A gate of the transmission transistor T3 is electrically connected to a data writing control signal line SP, and a second electrode of the transmission transistor T3 is electrically connected to a data signal line DATA, such that a data writing control signal on the data writing control signal line SP can control the transmission transistor T3 to be turned on or off. When the transmission transistor T3 is turned on, the data signal received by the second electrode of the transmission transistor T3 is written into the second node N2 and the gate of the drive transistor T1 (namely the first node N1). In addition, the pixel driver circuit 30 may further include a first reset transistor T4, a threshold compensation transistor T5, a power writing transistor T6, a second reset transistor T7, and a storage capacitor Cst. All transistors in the pixel driver circuit 30 may be low-temperature polysilicon (LTPS) transistors. It can be understood that the seven transistors in the pixel driver circuit 30 may be controlled by corresponding scanning signals (signals transmitted by a first scanning signal line Scan1, a second scanning signal line Scan2, the light-emitting control scanning signal line Emit, and the data writing control signal line SP) to be turned on or off, to control on/off of paths of the data signal transmitted by the data signal line DATA and a reset signal transmitted by a reset signal line Vref, and to control timing/time for providing the drive current to the light-emitting element 20.

Referring to FIG. 5 and FIG. 6, the light-emitting control scanning signal line Emit includes the first connection line 301. The first connection line 301 is one part of the light-emitting control scanning signal line Emit shown in a rectangular dashed-line box in FIG. 5. The first connection line 301 may be disposed in a same layer as or a different layer from other part of the light-emitting control scanning signal line Emit, which will not be limited herein. For example, FIG. 5 shows that the first connection line 301 is disposed in the same layer as the light-emitting control scanning signal line Emit, and is located in the first metal layer 32.

Referring to FIG. 5 and FIG. 6, the second connection line 302 is a part of a line electrically connected between the first electrode of the drive transistor T1 and the first electrode of the transmission transistor T3 shown in a rectangular dashed-line box in FIG. 5. The second connection line 302 is disposed in a different layer from the first connection line 301. A film layer of the shielding component 40 is located between a film layer of the first connection line 301 and a film layer of the second connection line 302. In the direction (namely the Z direction) perpendicular to the plane of the substrate 10, the shielding component 40, the first connection line 301, and the second connection line 302 overlap with each other. It can be understood that they may partially or completely overlap with each other, which may be adaptively configured based on an actual situation. For example, in FIG. 5 and FIG. 6, the first connection line 301 may be located in the first metal layer 32, the shielding component 40 may be located in the second metal layer 33, and the second connection line 302 may be located in the third metal layer 34, but not limited thereto.

Further, the shielding component 40 is configured to receive a DC voltage signal, which may be an existing positive voltage signal provided by a first power signal line PVDD of the display panel 100, or an existing DC voltage signal, or a new DC voltage signal, which is not limited herein. For example, FIG. 5 shows that the shielding component 40 is electrically connected to the first power signal line PVDD through a hole and configured to receive the positive voltage signal provided by the first power signal line PVDD. In this way, the shielding component 40 can prevent the light-emitting control scanning signal on the light-emitting control scanning signal line Emit from having coupling impact on a potential of the first electrode of the drive transistor T1. This resolves a problem in the related art that the display panel is not black in a black state when the pixel driver circuit 30 works in a low-frequency mode to drive the light-emitting element 20 to perform black-state display, thereby improving display uniformity, and thus improving display quality of the display panel 100.

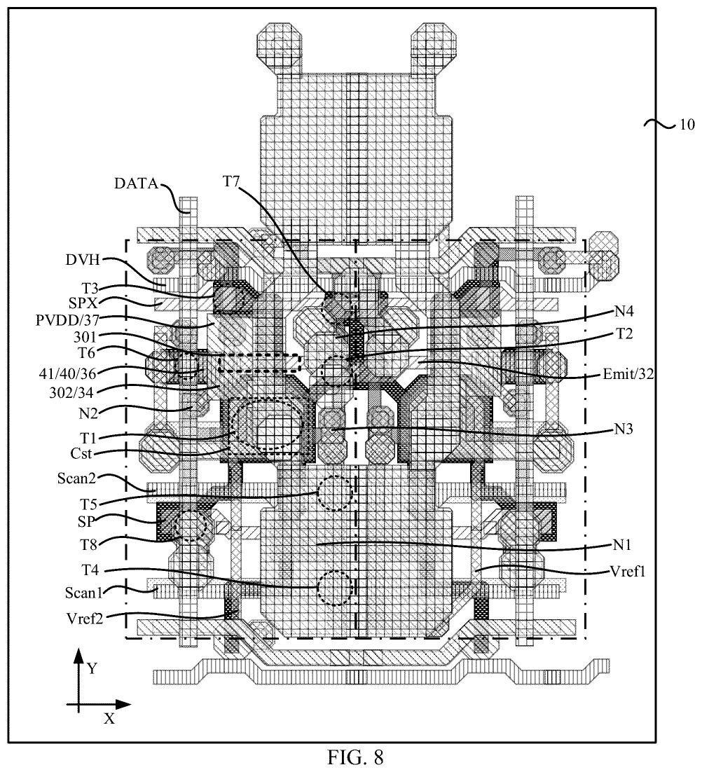

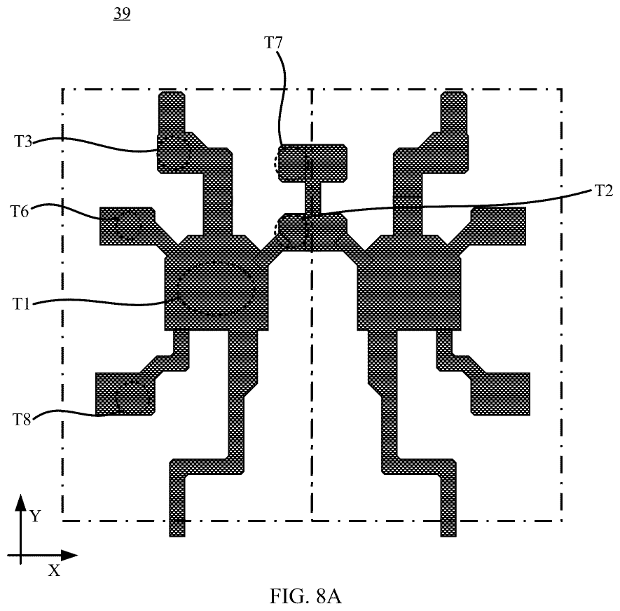

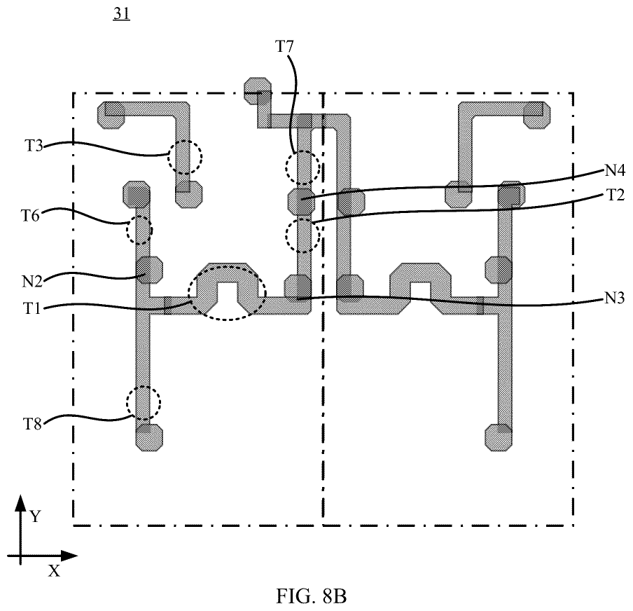

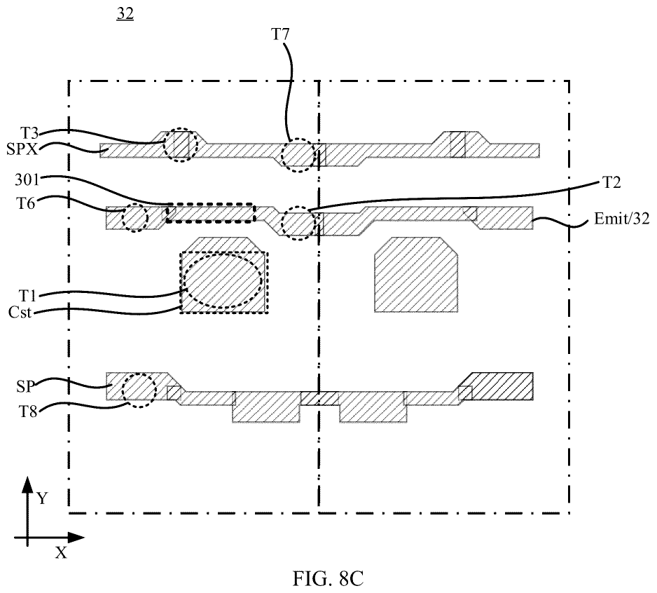

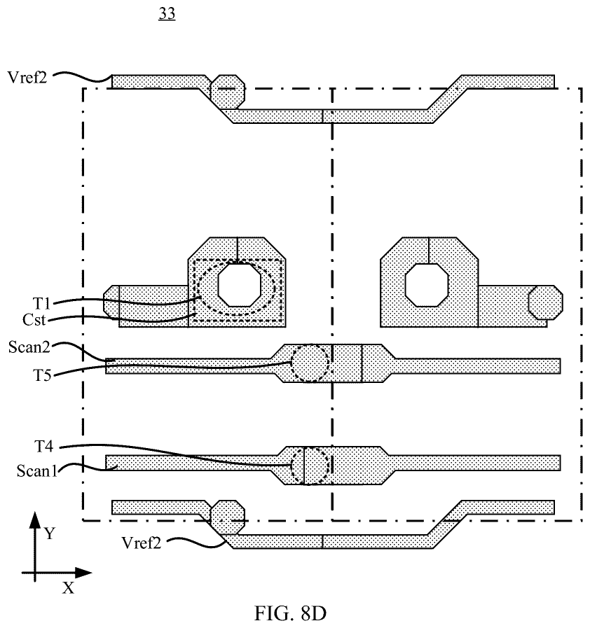

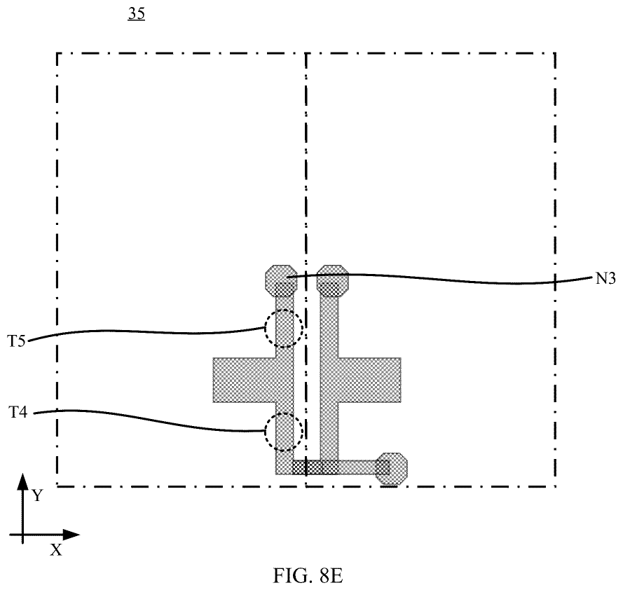

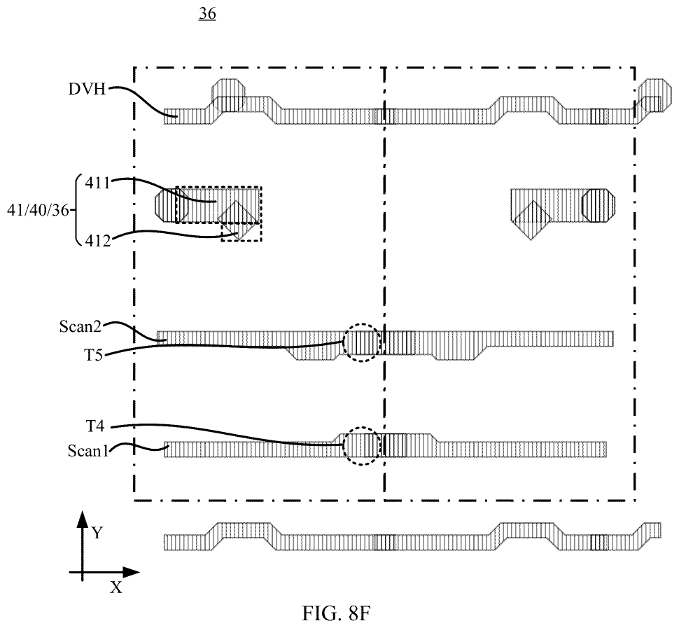

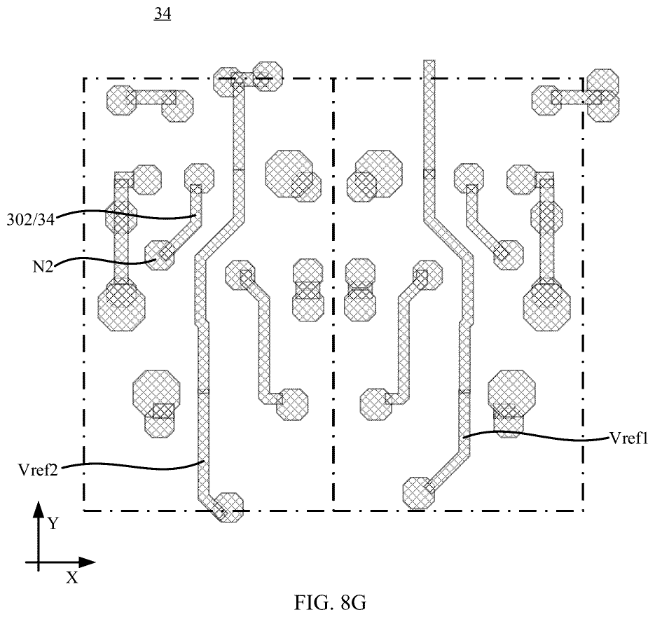

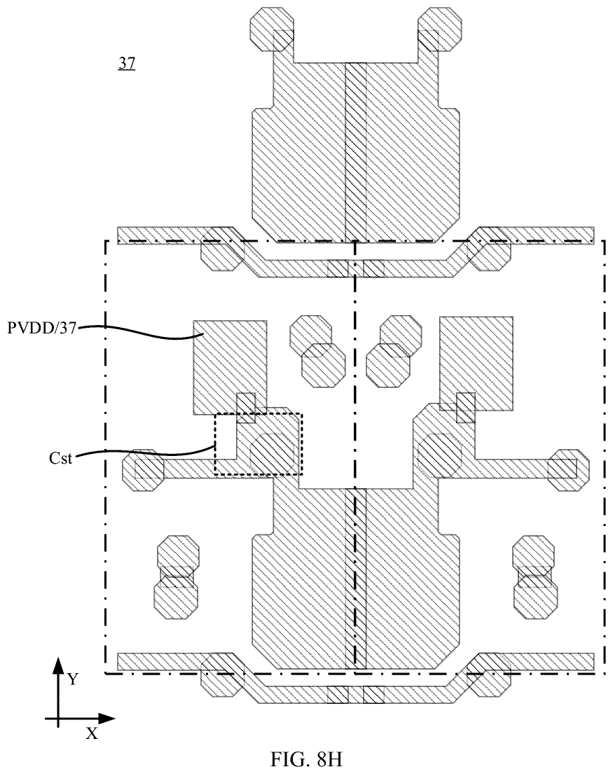

In another embodiment, FIG. 7 is another schematic diagram of an element structure of a pixel driver circuit according to an embodiment of the present disclosure. FIG. 8 is a schematic diagram of a film layer structure of the pixel driver circuit shown in FIG. 7. FIG. 8A to FIG. 8I each illustrate a structural schematic diagram of a film layer in FIG. 8. FIG. 9 is a structural schematic diagram of a cross section in FIG. 8.

The pixel driver circuit 30 shown in FIG. 7 differs in structure from that shown in FIG. 4 in that the transmission transistor T3 in the pixel driver circuit 30 is a bias adjustment transistor configured to write a bias adjustment voltage into the first electrode of the drive transistor T1. A gate of the transmission transistor T3 is electrically connected to a bias adjustment control signal line SPX. A second electrode of the transmission transistor T3 is electrically connected to an adjustment signal line DVH. In this way, a bias adjustment control signal on the bias adjustment control signal line SPX can control the transmission transistor T3 to be turned on or off. When the transmission transistor T3 is turned on, the bias adjustment voltage provided by the adjustment signal line DVH and received by the second electrode of the transmission transistor T3 can be written into the second node N2. In addition, the pixel driver circuit 30 may further include a first reset transistor T4, a threshold compensation transistor T5, a power writing transistor T6, a second reset transistor T7, a data writing transistor T8, and a storage capacitor Cst. The reset signal line Vref may include a first reset signal line Vref1 and a second reset signal line Vref2. The first reset signal line Vref1 is electrically connected to a second electrode of the first reset transistor T4. The second reset signal line Vref2 is electrically connected to a second electrode of the second reset transistor T7. In the pixel driver circuit 30, at least one transistor may be an LTPS transistor and at least one transistor may be an indium gallium zinc oxide (IGZO) transistor, such that the two types of transistors can be combined in the pixel driver circuit 30. That is, the LTPS transistor and the IGZO transistor may be combined to form the low-temperature polycrystalline oxide (LTPO) pixel driver circuit 30. This ensures that the pixel driver circuit 30 features a high switching speed, high carrier mobility, low costs, low power consumption, and small electric leakage.

Referring to FIG. 8 and FIG. 9, the display panel 100 may further include a second semiconductor layer 35 and a fourth metal layer 36. The second semiconductor layer 35 and the fourth metal layer 36 are both located between the second metal layer 33 and the third metal layer 34. The second semiconductor layer 35 is located at a side of the fourth metal layer 36 close to the second metal layer 33. The IGZO transistor (for example, the first reset transistor T4 and the threshold compensation transistor T5 in FIG. 9) may include an oxide semiconductor channel, a bottom gate, and a top gate. The bottom gate may be located in the second metal layer 33. The oxide semiconductor channel may be located in the second semiconductor layer 35. The top gate may be located in the fourth metal layer 36. In addition, the display panel 100 may further include a fifth metal layer 37 and a sixth metal layer 38. The fifth metal layer 37 and the sixth metal layer 38 are both located between the third metal layer 34 and the first electrode portion 21 of the light-emitting element 20. The fifth metal layer 37 is located at a side of the sixth metal layer 38 away from the substrate 10.

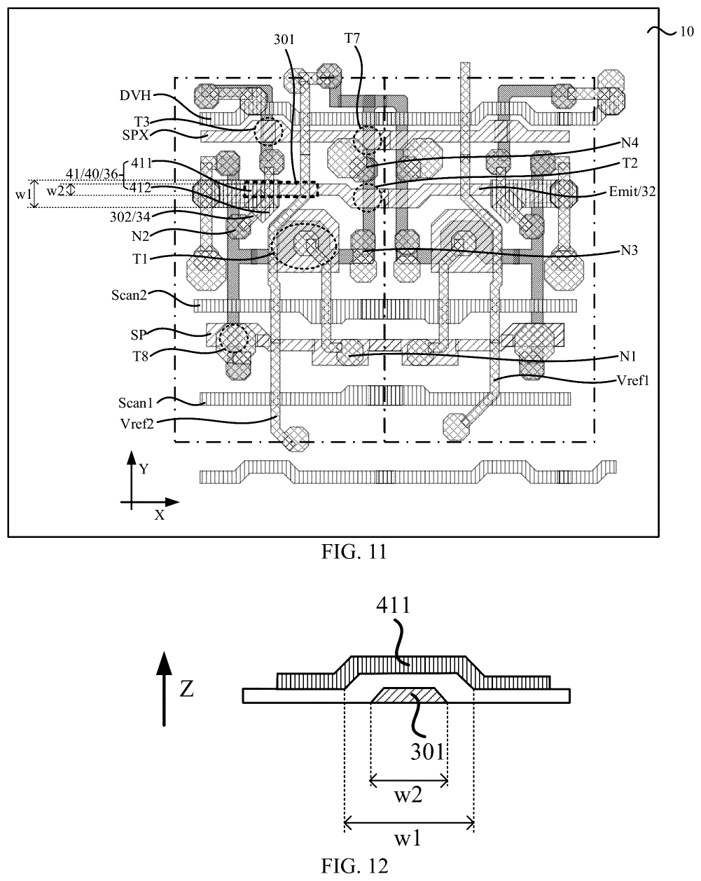

Referring to FIG. 8, FIG. 9, and FIG. 11, in an embodiment, the first connection line 301 may be located in the same layer as the light-emitting control scanning signal line Emit, that is, located in the first metal layer 32. The second connection line 302 may be located in the third metal layer 34. The shielding component 40 may be disposed in the second metal layer 33, the second semiconductor layer 35, or the fourth metal layer 36. This can be adaptively configured based on an actual situation. For example, the shielding component 40 shown in FIG. 8 and FIG. 9 may be located in the fourth metal layer 36, but not limited thereto.

Further, FIG. 8 exemplarily shows that the shielding component 40 is configured to receive a positive voltage signal provided by a first power signal line PVDD. The first power signal line PVDD is located in the fifth metal layer 37. In this way, the shielding component 40 can be electrically connected to the first power signal line PVDD through a hole. For example, the shielding component 40 is electrically connected to the third metal layer 34 through a hole, and then electrically connected to the first power signal line PVDD located in the fifth metal layer 37 through a hole. In this way, the shielding component 40 can prevent the light-emitting control scanning signal on the light-emitting control scanning signal line Emit from having coupling impact on a potential of the first electrode of the drive transistor T1. This resolves a problem in the related art that the display panel is not black in a black state when the pixel driver circuit 30 works in a low-frequency mode to drive the light-emitting element 20 to perform black-state display, thereby improving display uniformity, and thus improving display quality of the display panel 100.

It should be noted that for different structures of the pixel driver circuit 30, the film layers of the first connection line 301, the second connection line 302, and the shielding component 40 can be adaptively adjusted based on an actual situation, provided that in the direction (namely the Z direction) perpendicular to the plane of the substrate 10, the shielding component 40 is located between the first connection line 301 and the second connection line 302, and the shielding component 40, the first connection line 301, and the second connection line 302 overlap with each other.

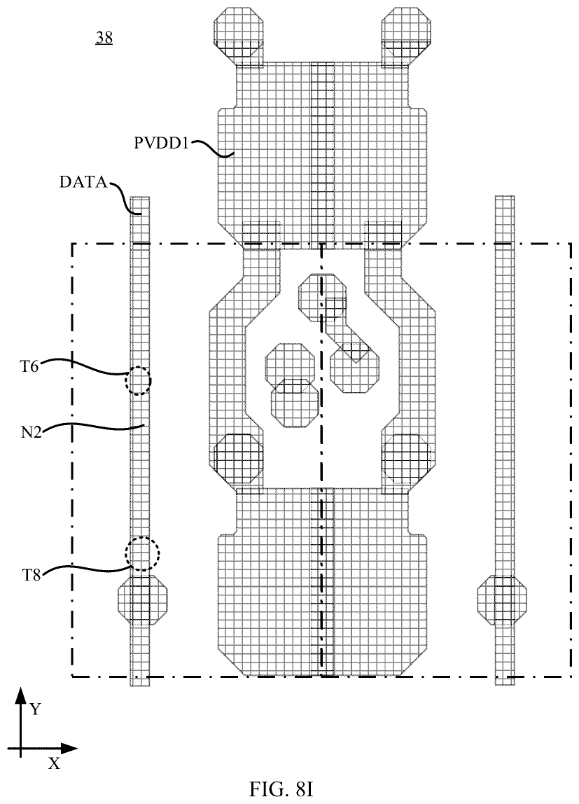

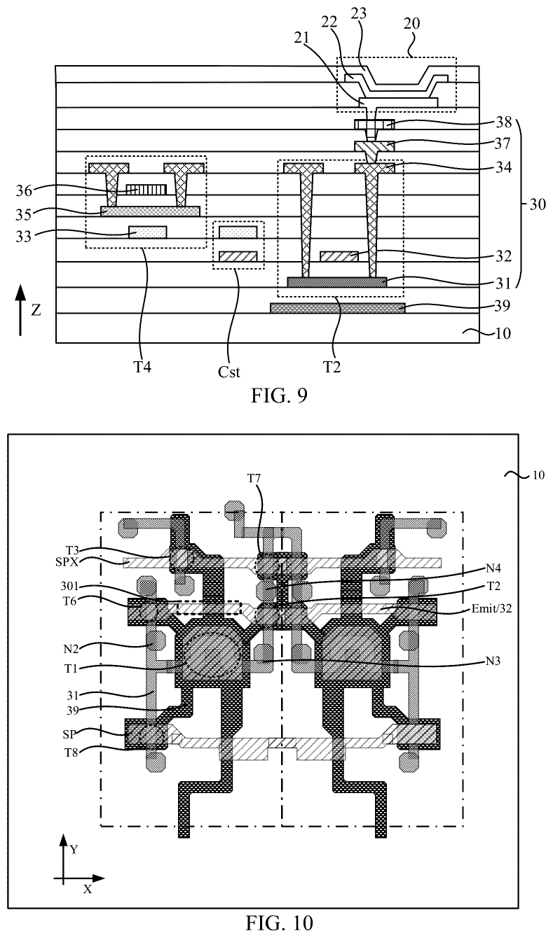

For example, FIG. 10 is a schematic diagram of a partial film layer structure in FIG. 8. Referring to FIG. 8 to FIG. 10, the display panel 100 may further include a light-shielding metal layer 39 located at a side of the first semiconductor layer 31 close to the substrate 10. The light-shielding metal layer may be a patterned structure. In the direction (namely the Z direction) perpendicular to the plane of the substrate 10, the light-shielding metal layer overlaps with a semiconductor layer (namely an active layer) of at least one transistor, to avoid current leakage due to illumination on the active layer of the transistor and improve working performance of the transistor.

To more clearly illustrate a structure of each film layer of the pixel driver circuit 30 in FIG. 8, FIG. 8A to FIG. 8I sequentially show structures of film layers of two adjacent pixel driver circuits 30 arranged in the first direction X. FIG. 8A is a structural schematic diagram of a light-shielding metal layer in FIG. 8. FIG. 8B is a structural schematic diagram of a first semiconductor layer in FIG. 8. FIG. 8C is a structural schematic diagram of a first metal layer in FIG. 8. FIG. 8D is a structural schematic diagram of a second metal layer in FIG. 8. FIG. 8E is a structural schematic diagram of a second semiconductor layer in FIG. 8. FIG. 8F is a structural schematic diagram of a fourth metal layer in FIG. 8. FIG. 8G is a structural schematic diagram of a third metal layer in FIG. 8. FIG. 8H is a structural schematic diagram of a fifth metal layer in FIG. 8. FIG. 8I is a structural schematic diagram of a sixth metal layer in FIG. 8.

Referring to FIG. 8A, FIG. 8B, and FIG. 10, a projection of the light-shielding metal layer 39 onto the substrate 10 overlaps with a projection of a channel of at least one transistor in the pixel driver circuit 30 onto the substrate 10.

Referring to FIG. 8B, FIG. 8C, and FIG. 10, an overlapping region where the first semiconductor layer 31 overlaps with the first metal layer 32 forms a channel of a transistor in the pixel driver circuit 30. The first semiconductor layer 31 may include silicon. The first metal layer 32 includes the bias adjustment control signal line SPX, the light-emitting control scanning signal line Emit, the data writing control signal line SP, and a first plate of the storage capacitor Cst. The first plate of the storage capacitor Cst is reused as the gate of the drive transistor T1.

Referring to FIG. 8D and FIG. 8, the second metal layer 33 includes a second plate of the storage capacitor, the first scanning signal line Scan1, and the second scanning signal line Scan2. The scanning signal line Scan1 is reused as a bottom gate of the first reset transistor T4. The second scanning signal line Scan2 is reused as a bottom gate of the threshold compensation transistor T5. The second metal layer 33 further includes a reset signal line extending in the first direction, for example, the second reset signal line Vref2 extending in the first direction X. It can be understood that the second metal layer 33 may further be provided with the first reset signal line Vref1 (not shown) extending in the first direction X.

Referring to FIG. 8E and FIG. 8, the second semiconductor layer 35 includes an oxide semiconductor material.

Referring to FIG. 8F and FIG. 8, the fourth metal layer 36 includes the adjustment signal line DVH, the shielding component 40, the first scanning signal line Scan1, and the second scanning signal line Scan2. The first scanning signal line Scan1 is reused as a top gate of the first reset transistor T4. The second scanning signal line Scan2 is reused as a top gate of the threshold compensation transistor T5.

Referring to FIG. 8G and FIG. 8, the third metal layer 34 includes the first reset signal line Vref1, the second reset signal line Vref2, and the second connection line 302. In the third metal layer 34, the first reset signal line Vref1 and the second reset signal line Vref2 extend in a second direction Y.

Referring to FIG. 8H and FIG. 8, the fifth metal layer 37 includes the first power signal line PVDD, and the second plate of the storage capacitor Cst is electrically connected to the first power signal line PVDD.

Referring to FIG. 8I and FIG. 8, the sixth metal layer 38 includes a data signal line DATA and a first auxiliary power signal line PVDD1. The data signal line DATA is electrically connected to a second electrode of the data writing transistor T8. The first auxiliary power signal line PVDD1 located in the sixth metal layer 38 is electrically connected to the first power signal line PVDD located in the fifth metal layer 37 through a conductive through-hole.

For example, referring to FIG. 4 to FIG. 6 (or FIG. 7 to FIG. 9), the pixel driver circuit 30 further includes a storage capacitor Cst. The storage capacitor Cst includes a first plate and a second plate. The first plate is reused as the gate of the drive transistor T1. In the direction (namely the Z direction) perpendicular to the plane of the substrate 10, the first plate is located between the substrate 10 and the second plate. The shielding component 40 includes a first shielding element 41. The first shielding element 41 is electrically connected to the second plate.

For example, the storage capacitor Cst is configured to store the data signal written into the gate of the drive transistor T1. The first plate of the storage capacitor Cst is reused as the gate of the drive transistor T1. That is, the first plate of the storage capacitor Cst may be located in the first metal layer 32. In this way, the first plate of the storage capacitor Cst does not need to be additionally disposed, thereby reducing space occupied by the pixel driver circuit 30. In the direction (namely the Z direction) perpendicular to the plane of the substrate 10, the first plate is located between the substrate 10 and the second plate. The second plate of the storage capacitor Cst may be located in the second metal layer 33.

Referring to FIG. 5 or FIG. 8, the first shielding element 41 is electrically connected to the second plate, and the second plate is electrically connected to the first power signal line PVDD, such that the first shielding element 41 is electrically connected to the first power signal line PVDD. In this way, the first shielding element 41 is configured to receive the positive voltage signal provided by the first power signal line PVDD, to prevent the light-emitting control scanning signal on the light-emitting control scanning signal line Emit from having coupling impact on the potential of the first electrode of the drive transistor T1.

It should be noted that the first shielding element 41 may be disposed in a same layer as or a different layer from the second plate, which will not be limited herein. In this case, electrical connection between the first shielding element 41 and the second plate may be a direct electrical connection integrally formed, or an indirect electrical connection implemented through an intermediate structure, for example, by a conductive through-hole or another connection line. This can be adaptively configured based on an actual situation.

FIG. 5 exemplarily shows that the first shielding element 41 and the second plate are located in the same layer, that is, located in the second metal layer 33. The first shielding element 41 may be electrically connected to the second plate through the first power signal line PVDD, but not limited thereto. In another embodiment, the first shielding element 41 and the second plate may be an integral structure.

FIG. 8 exemplarily shows that the first shielding element 41 and the second plate are located in different film layers. The first shielding element 41 is located in the fourth metal layer 36. The second plate is located in the second metal layer 33. The first shielding element 41 is electrically connected to the third metal layer 34 through a conductive through-hole, and then electrically connected to the second metal layer 33 through a conductive through-hole.

For example, referring to FIG. 4 or FIG. 7, the first shielding element 41 is configured to receive a first supply voltage Pvdd. The second electrode portion 23 is configured to receive a second supply voltage Pvee. The first supply voltage Pvdd is higher than the second supply voltage Pvee.

For example, the first supply voltage Pvdd is a positive voltage signal provided by the first power signal line PVDD. The second electrode portion 23 is a cathode of the light-emitting element 20. The second supply voltage Pvee is a negative voltage signal provided by a second power signal line PVEE. The first supply voltage Pvdd is higher than the second supply voltage Pvee. When the first supply voltage Pvdd is transmitted to the first electrode of the drive transistor T1, the second supply voltage Pvee is written into the second electrode portion 23 of the light-emitting element 20, in this case, a current path is formed from the first supply voltage Pvdd to the second supply voltage Pvee when the power writing transistor T6 and the light-emitting control transistor T2 are turned on, such that the drive transistor T1 generates a drive current based on a voltage difference between the data signal written into the gate thereof and the first supply voltage Pvdd of the first electrode thereof, to drive the light-emitting element 20 to emit light.

For example, referring to FIG. 5 and FIG. 6, the first shielding element 41 is disposed in the same layer as the second plate.

For example, the second plate is located in the second metal layer 33, and the first shielding element 41 is disposed in the same layer as the second plate, such that the first shielding element 41 is also located in the second metal layer 33, in this way, the first shielding element 41 and the second plate of the storage capacitor Cst can be simultaneously formed by using a same metal layer in a same process, to reduce processes.

For example, referring to FIG. 7 and FIG. 9, the pixel driver circuit 30 further includes the first reset transistor T4. A first electrode of the first reset transistor T4 is electrically connected to the first plate. The first reset transistor T4 includes an oxide semiconductor channel and a top gate. In the direction (namely the Z direction) perpendicular to the plane of the substrate 10, a film layer of the oxide semiconductor channel is located between a film layer of the second plate and a film layer of the top gate. The first shielding element 41 is disposed in a same layer as the top gate.

For example, the first plate of the storage capacitor Cst in the pixel driver circuit 30 is reused as the gate of the drive transistor T1. The first plate may be located in the first metal layer 32. The second plate may be located in the second metal layer 33. The first reset transistor T4 may include the oxide semiconductor channel, the bottom gate, and the top gate. In the direction (namely the Z direction) perpendicular to the plane of the substrate 10, the film layer of the oxide semiconductor channel is located between the film layer of the second plate and the film layer of the top gate. In this way, the bottom gate may be located in the second metal layer 33, the oxide semiconductor channel may be located in the second semiconductor layer 35, and the top gate may be located in the fourth metal layer 36. Further, the first shielding element 41 is disposed in the same layer as the top gate. That is, the first shielding element 41 may be located in the fourth metal layer 36. In this way, the first shielding element 41 and the top gate of the first reset transistor T4 can be simultaneously formed by using the same metal layer in a same process, to reduce processes.

For example, FIG. 11 is another schematic diagram of a partial film layer structure in FIG. 8. FIG. 12 is a schematic diagram of a cross section of a partial film layer structure in FIG. 11. Referring to FIG. 5, FIG. 11, and FIG. 12, the first shielding element 41 includes a first shielding sub-element 411. In the direction (namely the Z direction) perpendicular to the plane of the substrate, the first shielding sub-element 411 overlaps with the first connection line 301 and the second connection line 302. A width of the first shielding sub-element 411 in the second direction Y is greater than a width of the first connection line 301 in the second direction Y. The first direction X intersects the second direction Y.

For example, the width of the first shielding sub-element 411 in the second direction Y is w1. The width of the first connection line 301 in the second direction Y is w2. In an embodiment, w1 is set to be greater than w2, such that the first shielding sub-element 411 can completely prevent the light-emitting control scanning signal transmitted on the first connection line 301 from having coupling impact on the potential of the first electrode of the drive transistor T1, to improve the display quality of the display panel 100. In addition, referring to FIG. 12, because an insulation layer between the first connection line 301 and the first shielding sub-element 411 is thin at some special positions (such as edges or corners) of the display panel 100 and is prone to breakage, resulting in a risk of a short circuit of the first connection line 301 and the first shielding sub-element 411, the width w1 of the first shielding sub-element 411 in the second direction Y is set to be greater than the width w2 of the first connection line 301 in the second direction Y, such that a dimension of the insulation layer between the first connection line 301 and the first shielding sub-element 411 can be increased in the first direction X. This can avoid the risk of a short circuit of the first connection line 301 and the first shielding sub-element 411, to improve reliability of the display panel 100.

For example, referring to FIG. 5 and FIG. 11, the first shielding element 41 includes a first shielding sub-element 411 and a second shielding sub-element 412. In the direction (namely the Z direction) perpendicular to the plane of the substrate 10, the first shielding sub-element 411 overlaps with the first connection line 301 and the second connection line 302. The second shielding sub-element 412 is disposed in a same layer as and electrically connected to the first shielding sub-element 411. In the direction (namely the Z direction) perpendicular to the plane of the substrate 10, the second shielding sub-element 412 overlaps with the second connection line 302.

For example, there may be one or more second shielding sub-elements 412, which may be located at a side or two sides of the first shielding sub-element 411. This is not limited herein. That the second shielding sub-element 412 is disposed in the same layer as and electrically connected to the first shielding sub-element 411 may mean that they are an integral structure or are electrically connected through another connection line. This is not limited herein. The second shielding sub-element 412 overlaps with the second connection line 302, in comparison with a case that only the first shielding sub-element 411 is provided, a shielding area of the first shielding element 41 can be increased, thereby further preventing the light-emitting control scanning signal on the light-emitting control scanning signal line Emit from having coupling impact on the potential of the first electrode of the drive transistor T1, to improve the display quality of the display panel 100.

For example, referring to FIG. 7, the display panel 100 further includes an adjustment signal line DVH electrically connected to the second electrode of the transmission transistor T3. The shielding component 40 includes a second shielding element 42. The second shielding element 42 is electrically connected to the adjustment signal line DVH.

For example, the adjustment signal line DVH may also provide a DC voltage signal. When the transmission transistor T3 is turned on, the DC voltage signal is written into the first electrode of the drive transistor T1, to reset the potential of the first electrode of the drive transistor T1.

For example, the adjustment signal line DVH is configured to transmit a bias adjustment voltage. The transmission transistor T3 is a bias adjustment transistor configured to write the bias adjustment voltage into the first electrode of the drive transistor T1. When the transmission transistor T3 is turned on, the bias adjustment voltage on the adjustment signal line DVH can be written into the first electrode of the drive transistor T1. This resolves a characteristic offset or hysteresis issue of the drive transistor T1 after long-term operation, avoids a flicker when the display panel 100 maintains image display, and improves a display effect.

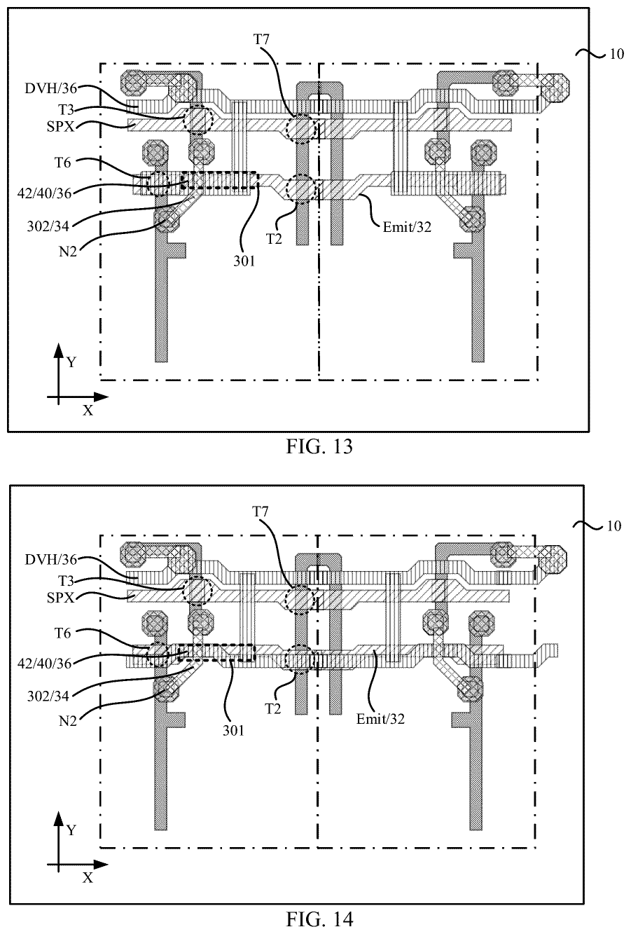

Further, FIG. 13 is a partial schematic diagram of a partial film layer structure of the pixel driver circuit shown in FIG. 7. Herein, a partial schematic diagram means that at least one film layer is omitted, and/or a pattern of a partial region in a film layer is omitted. Referring to FIG. 7 and FIG. 13, the second shielding element 42 is electrically connected to the adjustment signal line DVH, such that the second shielding element 42 is configured to receive the bias adjustment voltage provided by the adjustment signal line DVH, to prevent the light-emitting control scanning signal on the light-emitting control scanning signal line Emit from having coupling impact on the potential of the first electrode of the drive transistor T1.

It should be noted that the second shielding element 42 may be located in a same layer as or a different layer from the adjustment signal line DVH. This can be configured based on an actual situation.

For example, referring to FIG. 13, the second shielding element 42 is disposed in the same layer as the adjustment signal line DVH, such that the second shielding element 42 and the adjustment signal line DVH can be simultaneously formed by using a same metal layer in a same process, to reduce processes.

For example, the second shielding element 42 shown in FIG. 13 and the adjustment signal line DVH may be located in the same layer, that is, located in the fourth metal layer 36. The first connection line 301 may be located in the first metal layer 32. The second connection line 302 may be located in the third metal layer 34. In the direction (namely the Z direction) perpendicular to the plane of the substrate 10, the second shielding element 42 is located between the first connection line 301 and the second connection line 302, and the second shielding element 42, the first connection line 301, and the second connection line 302 overlap with each other, such that the second shielding element 42 can prevent the light-emitting control scanning signal on the light-emitting control scanning signal line Emit from having coupling impact on the potential of the first electrode of the drive transistor T1.

For example, FIG. 14 is another partial schematic diagram of a partial film layer structure of the pixel driver circuit shown in FIG. 7. Referring to FIG. 7 and FIG. 14, a plurality of pixel driver circuits 30 arranged in the first direction X share a same second shielding element 42.

For example, the second shielding element 42 may be a structure extending in the first direction X. In each pixel driver circuit 30, the second shielding element 42 may overlap with the first connection line 301 and the second connection line 302 in the direction (namely the Z direction) perpendicular to the plane of the substrate 10, to prevent the light-emitting control scanning signal on the light-emitting control scanning signal line Emit from having coupling impact on the potential of the first electrode of the drive transistor T1. The plurality of pixel driver circuits 30 arranged in the first direction X share a same second shielding element 42. This can simplify a line layout and reduce process difficulty. In addition, the second shielding element 42 and the adjustment signal line DVH form a parallel structure. This can reduce line impedance of the adjustment signal line DVH, to reduce loss of the bias adjustment voltage transmitted on the adjustment signal line DVH.

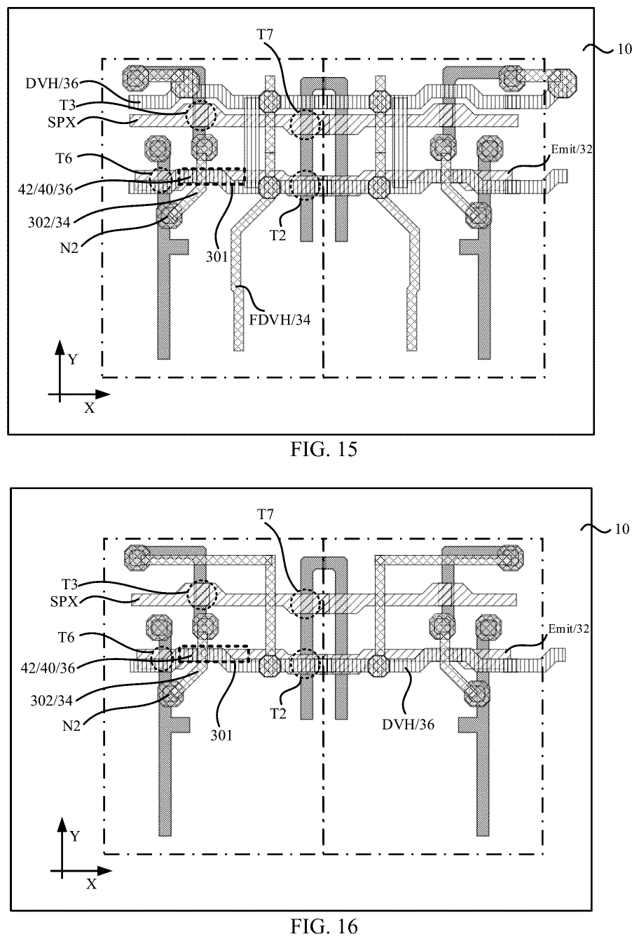

For example, FIG. 15 is another partial schematic diagram of a partial film layer structure of the pixel driver circuit shown in FIG. 7. As shown in FIG. 15, the adjustment signal line DVH extends in the first direction X. The display panel 100 further includes an auxiliary adjustment signal line FDVH extending in the second direction Y, and the auxiliary adjustment signal line FDVH is electrically connected to the adjustment signal line DVH and/or the second shielding element 42 through a through-hole. The first direction X intersects the second direction Y.

Referring to FIG. 15, the auxiliary adjustment signal line FDVH may be disposed in a different layer from the second shielding element 42 and the adjustment signal line DVH. The second shielding element 42 and the adjustment signal line DVH are both located in the fourth metal layer 36. The auxiliary adjustment signal line FDVH may be disposed in any film layer. This is not limited herein. FIG. 15 exemplarily shows that the auxiliary adjustment signal line FDVH may be located in the second metal layer 33, but not limited thereto.

Further, because the adjustment signal line DVH is electrically connected to the second shielding element 42, the auxiliary adjustment signal line FDVH may be electrically connected to the adjustment signal line DVH or the second shielding element 42 through a through-hole, or electrically connected to both the adjustment signal line DVH and the second shielding element 42 through a through-hole. This can be adaptively configured based on an actual situation. FIG. 15 merely exemplarily shows a case that the auxiliary adjustment signal line FDVH is electrically connected to both the adjustment signal line DVH and the second shielding element 42 through a through-hole, but not limited thereto. In this way, the auxiliary adjustment signal line FDVH and the adjustment signal line DVH form a mesh structure. This further reduces the line impedance of the adjustment signal line DVH, to reduce the loss of the bias adjustment voltage transmitted on the adjustment signal line DVH.

For example, FIG. 16 is another partial schematic diagram of a partial film layer structure of the pixel driver circuit shown in FIG. 7. As shown in FIG. 16, the second shielding element 42 is reused as the adjustment signal line DVH.

For example, the first connection line 301 may be located in the first metal layer 32. The second connection line 302 may be located in the third metal layer 34. The adjustment signal line DVH may be located in the fourth metal layer 36. In the direction (namely the Z direction) perpendicular to the plane of the substrate 10, the fourth metal layer 36 is located between the first metal layer 32 and the third metal layer 34. In this way, the second shielding element 42 may be reused as the adjustment signal line DVH. In other words, the second shielding element 42 is located in the fourth metal layer 36. In this way, the second shielding element 42 does not need to be additionally disposed, to simplify the line layout and prevent the light-emitting control scanning signal on the light-emitting control scanning signal line Emit from having coupling impact on the potential of the first electrode of the drive transistor T1, to improve the display quality of the display panel 100.

It should be noted that line layouts in FIG. 13 to FIG. 16 are merely examples, and positions of connection through-holes are also merely examples. A specific line layout and positions of the through-holes can be adaptively adjusted based on an actual situation.

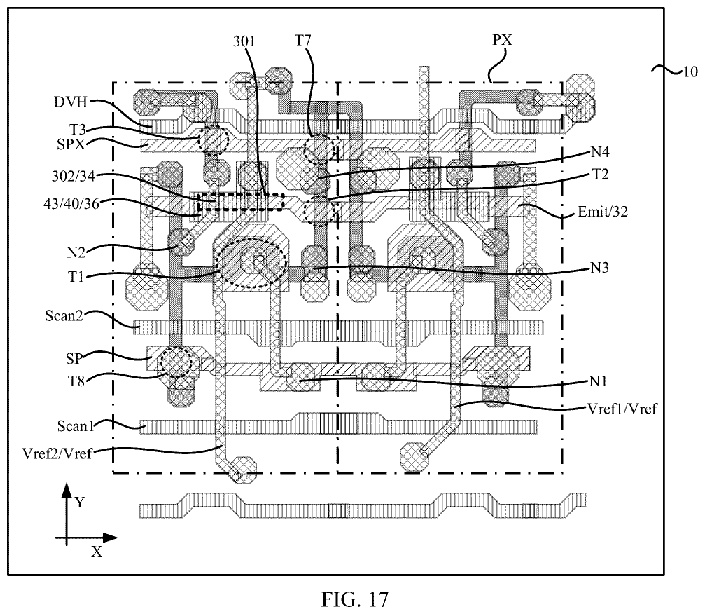

For example, FIG. 17 is another schematic diagram of a partial film layer structure of the pixel driver circuit shown in FIG. 7. Referring to FIG. 7 and FIG. 17, the display panel 100 further includes a reset signal line Vref and a reset transistor T. The reset transistor T includes a first electrode electrically connected to the gate of the drive transistor T1 or the first electrode portion 21, and a second electrode electrically connected to the reset signal line Vref. The shielding component 40 includes a third shielding element 43. The third shielding element 43 is electrically connected to the reset signal line Vref.

For example, the reset transistor T in the pixel driver circuit 30 may be the first reset transistor T4. The first reset transistor T4 includes a first electrode electrically connected to the gate of the drive transistor T1, and is configured to write a reset signal provided by the reset signal line Vref into the gate of the drive transistor T1 when turned on, to reset the potential of the gate of the drive transistor T1. Alternatively, the reset transistor T may be the second reset transistor T7. The second reset transistor T7 includes a first electrode electrically connected to the first electrode portion 21, and is configured to write a reset signal provided by the reset signal line Vref into the first electrode portion 21 of the light-emitting element 20 when turned on, to reset the potential of the first electrode portion 21 and avoid affecting normal light emission of the light-emitting element 20 in a next frame.

It should be noted that the second electrodes of the first reset transistor T4 and the second reset transistor T7 may be connected to a same reset signal line Vref or different reset signal lines Vref. This can be configured based on an actual situation.

Referring to FIG. 17, the third shielding element 43 may be electrically connected to the reset signal line Vref, such that a reset voltage transmitted by the reset signal line Vref can be provided to the third shielding element 43, to prevent the light-emitting control scanning signal on the light-emitting control scanning signal line Emit from having coupling impact on the potential of the first electrode of the drive transistor T1.

It should be noted that the third shielding element 43 may be disposed in a same layer as or a different layer from the reset signal line Vref. In addition, the third shielding element 43 and the reset signal line Vref may be integrally formed to be directly electrically connected, or may be indirectly electrically connected through an intermediate structure (for example, a through-hole or a connection line). This can be configured based on an actual situation.

For example, referring to FIG. 17, the second connection line 302 and the reset signal line Vref are disposed in the same layer. That is, the second connection line 302 and the reset signal line Vref may both be located in the third metal layer 34. In this way, the second connection line 302 and the reset signal line Vref can be simultaneously formed by using the same metal layer in a same process, to reduce processes.

For example, the third shielding element 43 shown in FIG. 17 may be located in the fourth metal layer 36. The first connection line 301 may be located in the first metal layer 32. The second connection line 302 and the reset signal line Vref may be located in the same layer, that is, located in the third metal layer 34. In the direction (namely the Z direction) perpendicular to the plane of the substrate 10, the third shielding element 43 is located between the first connection line 301 and the second connection line 302, and the second shielding element 42, the first connection line 301, and the second connection line 302 overlap with each other, such that the second shielding element 42 can prevent the light-emitting control scanning signal on the light-emitting control scanning signal line Emit from having coupling impact on the potential of the first electrode of the drive transistor T1.

For example, referring to FIG. 7 and FIG. 17, a plurality of reset transistors T include the first reset transistor T4 and the second reset transistor T7. A plurality of reset signal lines Vref include the first reset signal line Vref1 and the second reset signal line Vref2. The first electrode of the first reset transistor T4 is electrically connected to the gate of the drive transistor T1. The second electrode of the first reset transistor T4 is electrically connected to the first reset signal line Vref1. The first electrode of the second reset transistor T7 is electrically connected to the first electrode portion 21. The second electrode of the second reset transistor T7 is electrically connected to the second reset signal line Vref2.

The first reset signal line Vref1 and the second reset signal line Vref2 may transmit a same voltage signal or different voltage signals. When the first reset signal line Vref1 and the second reset signal line Vref2 transmit a same voltage signal, the third shielding element 43 may be electrically connected to both the first reset signal line Vref1 and the second reset signal line Vref2. When the first reset signal line Vref1 and the second reset signal line Vref2 transmit different voltage signals, the third shielding element 43 may be electrically connected to the first reset signal line Vref1 or the second reset signal line Vref2. This can be adaptively configured based on an actual situation.

For example, FIG. 17 shows two adjacent pixel driver circuits 30 arranged in the first direction X. The third shielding element 43 of one pixel driver circuit 30 is electrically connected to the second reset signal line Vref2, and the third shielding element 43 of another pixel driver circuit 30 is electrically connected to the first reset signal line Vref1. In addition, two adjacent pixel driver circuits 30 arranged in the first direction X share a same first reset signal line Vref1 and share a same second reset signal line Vref2, to simplify the line layout and reduce space occupied by the pixel driver circuits 30.

For example, referring to FIG. 7 and FIG. 17, the transmission transistor T3 is a bias adjustment transistor configured to write a bias adjustment voltage into the first electrode of the drive transistor T1. The reset signal line Vref is configured to transmit a reset voltage.

For example, the reset transistor T may be the second reset transistor T7. The gate of the transmission transistor T3 and a gate of the second reset transistor T7 may both be electrically connected to the bias adjustment control signal line SPX. The second electrode of the transmission transistor T3 may be electrically connected to the adjustment signal line DVH. In this way, the bias adjustment control signal on the bias adjustment control signal line SPX can control the transmission transistor T3 and the second reset transistor T7 to be turned on or off. When the transmission transistor T3 is turned on, the bias adjustment voltage provided by the adjustment signal line DVH and received by the second electrode of the transmission transistor T3 can be written into the second node N2 to reset the second node N2. This resolves a characteristic offset or hysteresis issue of the drive transistor T1 after long-term operation, avoids a flicker when the display panel 100 maintains image display, and improves the display effect. When the second reset transistor T7 is turned on, the reset voltage provided by the reset signal line Vref (namely the second reset signal line Vref2) and received by the second electrode of the second reset transistor T7 can be written into the fourth node N4 to reset the first electrode portion 21 of the light-emitting element 20. This ensures normal light emission of the light-emitting element 20.

For example, referring to FIG. 17, the display panel 100 includes a plurality of pixel sub-regions PX. The reset signal line Vref extends in the second direction Y. The first direction X intersects the second direction Y. In a same pixel sub-region PX, in the first direction X, an orthographic projection of the second connection line 302 onto the substrate 10 and an orthographic projection of a channel of the drive transistor T1 onto the substrate 10 are respectively located at two sides of an orthographic projection of the reset signal line Vref onto the substrate 10.

For example, in the first direction X, the orthographic projection of the second connection line 302 onto the substrate 10 and the orthographic projection of the channel of the drive transistor T1 onto the substrate 10 are respectively located at two sides of the orthographic projection of the reset signal line Vref onto the substrate 10, such that the orthographic projection of the reset signal line Vref onto the substrate 10 is close to the orthographic projection of the second connection line 302 onto the substrate 10. In the direction perpendicular to the plane of the substrate 10, the third shielding element 43 overlaps the second connection line 302, such that an orthographic projection of the third shielding element 43 onto the substrate 10 is close to the orthographic projection of the second connection line 302 onto the substrate 10. In this way, the third shielding element 43 can be electrically connected to the reset signal line Vref within a short distance, to simplify the line layout.

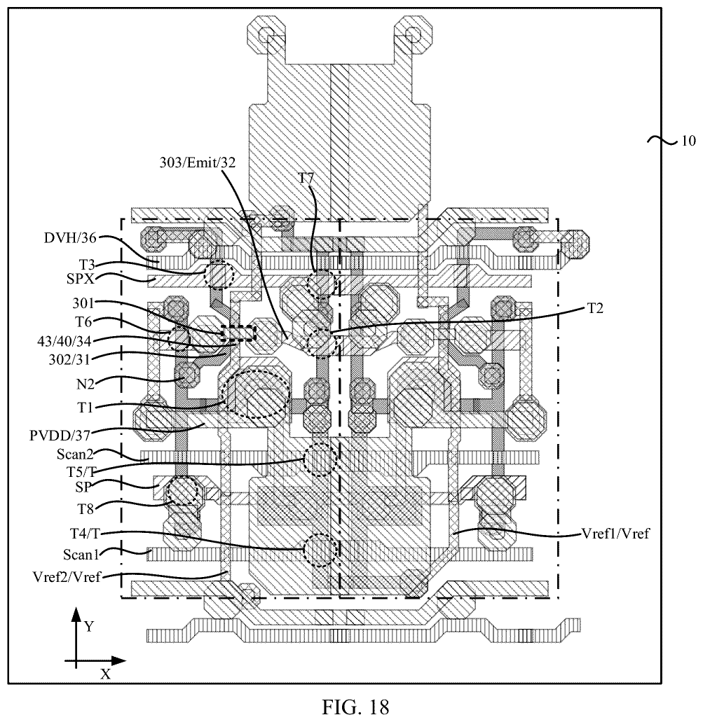

For example, FIG. 18 is another schematic diagram of a partial film layer structure of the pixel driver circuit shown in FIG. 7. Referring to FIG. 7 and FIG. 18, the light-emitting control scanning signal line Emit further includes a third connection line 303. The third connection line 303 is electrically connected to the first connection line 301 through a through-hole. The third connection line 303 is reused as the gate of the light-emitting control transistor T2. In the direction (namely the Z direction) perpendicular to the plane of the substrate 10, a film layer of the first connection line 301 is located at a side of a film layer of the third connection line 303 away from the substrate 10, and a film layer of the second connection line 302 is located between the film layer of the third connection line 303 and the substrate 10.

For example, the first connection line 301 and the third connection line 303 may be located in different layers and electrically connected through a through-hole. The third connection line 303 is reused as the gate of the light-emitting control transistor T2, such that an overlapping region where the third connection line 303 overlaps with the first semiconductor layer 31 is a channel of the light-emitting control transistor T2.

Referring to FIG. 18, in the direction (namely the Z direction) perpendicular to the plane of the substrate 10, the film layer of the first connection line 301 is located at the side of the film layer of the third connection line 303 away from the substrate 10, and the film layer of the second connection line 302 is located between the film layer of the third connection line 303 and the substrate 10. In other words, in the direction (namely the Z direction) perpendicular to the plane of the substrate 10, the film layer of the third connection line 303 is located between the film layer of the first connection line 301 and the film layer of the second connection line 302. The film layers of the first connection line 301, the second connection line 302, and the third connection line 303 can be adaptively configured based on an actual situation and are not limited in this embodiment.

For example, the second connection line 302 shown in FIG. 18 may be located in the first semiconductor layer 31. Because the third connection line 303 is located at a side of the film layer of the second connection line 302 away from the substrate 10, the third connection line 303 may be disposed in the first metal layer 32. Because the film layer of the first connection line 301 is located at the side of the film layer of the third connection line 303 away from the substrate 10, the first connection line 301 may be disposed in the second metal layer 33 or a metal layer above the second metal layer 33. For example, the first connection line 301 may be disposed in the fifth metal layer 37, but not limited thereto.

In this embodiment, in the direction (namely the Z direction) perpendicular to the plane of the substrate 10, a distance between the first connection line and the second connection line 302 is greater than a distance between the third connection line 303 and the second connection line 302, and, the first connection line 301 overlaps with the second connection line 302. In comparison with the solution in the related art, a distance between the first connection line 301 and the second connection line 302 is increased, thereby reducing parasitic capacitance between the first connection line 301 and the second connection line 302, and thus reducing coupling impact of the light-emitting control scanning signal on the light-emitting control scanning signal line Emit on a voltage of the second node N2, and resolving a problem in the related art that the display panel is not black in a black state and has display non-uniformity when the pixel driver circuit 30 works in a low-frequency mode to drive the light-emitting element 20 to perform black-state display, to improve the display quality of the display panel 100.

For example, referring to FIG. 7 and FIG. 18, the display panel 100 further includes a reset signal line Vref and a reset transistor T. The reset transistor T includes a first electrode electrically connected to the gate of the drive transistor T1 or the first electrode portion 21, and a second electrode electrically connected to the reset signal line Vref.

The reset signal line Vref may include a first reset signal line Vref1 and a second reset signal line Vref2.

For example, referring to FIG. 7, the reset transistor T in the pixel driver circuit 30 may be the first reset transistor T4. The first electrode of the first reset transistor T4 is electrically connected to the gate of the drive transistor T1. The second electrode of the first reset transistor T4 is electrically connected to the first reset signal line Vref1. Alternatively, the reset transistor T may be the second reset transistor T7. The first electrode of the second reset transistor T7 is electrically connected to the first electrode portion 21. The second electrode of the second reset transistor T7 is electrically connected to the second reset signal line Vref2. Details are not described herein again.

Further, referring to FIG. 18, in the direction (namely the Z direction) perpendicular to the plane of the substrate 10, the first connection line 301 is located at a side of the reset signal line Vref away from the substrate 10.

For example, the reset signal line Vref may be located in the third metal layer 34, such that the first connection line 301 may be located in the fifth metal layer 37 or the sixth metal layer 38. FIG. 18 exemplarily shows that the first connection line 301 is located in the fifth metal layer 37, but not limited thereto. In this way, the distance between the first connection line 301 and the second connection line 302 can be sufficiently large, to reduce parasitic capacitance between them, thereby further reducing coupling impact of the light-emitting control scanning signal on the light-emitting control scanning signal line Emit on the potential of the first electrode of the drive transistor T1, to improve the display quality of the display panel 100.

For example, referring to FIG. 18, the shielding component 40 includes a third shielding element 43. The third shielding element 43 is reused as the reset signal line Vref.

For example, FIG. 18 exemplarily shows that the reset signal line Vref may be located in the third metal layer 34. The third shielding element 43 may be reused as the reset signal line Vref. That is, the third shielding element 43 is located in the third metal layer 34. The first connection line 301 is located in the fifth metal layer 37. The second connection line 302 is located in the first semiconductor layer 31. In the direction (namely the Z direction) perpendicular to the plane of the substrate 10, the third shielding element 43 (namely the reset signal line Vref) is located between the first connection line 301 and the second connection line 302, to prevent the light-emitting control scanning signal on the light-emitting control scanning signal line Emit from having coupling impact on the potential of the first electrode of the drive transistor T1, to improve the display quality of the display panel 100. In addition, the third shielding element 43 is reused as the reset signal line Vref, and the shielding component 40 does not need to be additionally disposed, to simplify the line layout and reduce the space occupied by the pixel driver circuit 30.

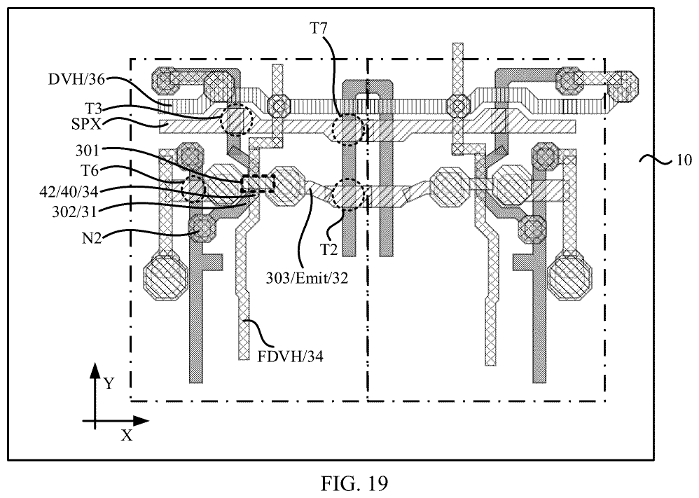

For example, FIG. 19 is another partial schematic diagram of a partial film layer structure of the pixel driver circuit shown in FIG. 7. Referring to FIG. 7 and FIG. 19, the display panel 100 further includes an adjustment signal line DVH and an auxiliary adjustment signal line FDVH. The adjustment signal line DVH extends in the first direction X and is electrically connected to the second electrode of the transmission transistor T3. The auxiliary adjustment signal line FDVH extends in the second direction Y and is electrically connected to the adjustment signal line DVH through a through-hole. The first direction X intersects the second direction Y. In the direction (namely the Z direction) perpendicular to the plane of the substrate 10, a film layer of the adjustment signal line DVH is located between a film layer of the third connection line 303 and a film layer of the auxiliary adjustment signal line FDVH. The shielding component 40 includes a second shielding element 42. The second shielding element 42 is reused as the auxiliary adjustment signal line FDVH.

For example, the adjustment signal line DVH is configured to transmit a bias adjustment voltage. The adjustment signal line DVH is configured to write the bias adjustment voltage into the first electrode of the drive transistor T1 when the transmission transistor T3 is turned on. This resolves a characteristic offset or hysteresis issue of the drive transistor T1 after long-term operation, avoids a flicker when the display panel 100 maintains image display, and improves the display effect.

Further, the auxiliary adjustment signal line FDVH may be located in a same layer as or a different layer from the adjustment signal line DVH. FIG. 19 exemplarily shows that the auxiliary adjustment signal line FDVH and the adjustment signal line DVH may be located in different layers and may be electrically connected through a through-hole, such that the auxiliary adjustment signal line FDVH can also transmit the bias adjustment voltage. In this way, the auxiliary adjustment signal line FDVH and the adjustment signal line DVH may form a mesh structure. This reduces the line impedance of the adjustment signal line DVH, to reduce the loss of the bias adjustment voltage transmitted on the adjustment signal line DVH.

Referring to FIG. 19, the adjustment signal line DVH is located between the third connection line 303 and the auxiliary adjustment signal line FDVH. The third connection line 303 may be located in the first metal layer 32. The auxiliary adjustment signal line FDVH may be located in the third metal layer 34. The adjustment signal line DVH may be located in the fourth metal layer 36. The second shielding element 42 is reused as the auxiliary adjustment signal line FDVH, such that the auxiliary adjustment signal line FDVH can prevent the light-emitting control scanning signal on the light-emitting control scanning signal line Emit from having coupling impact on the potential of the first electrode of the drive transistor T1, to improve the display quality of the display panel 100. In addition, the second shielding element 42 does not need to be additionally disposed. This helps simplify the line layout and reduce the space occupied by the pixel driver circuit 30.

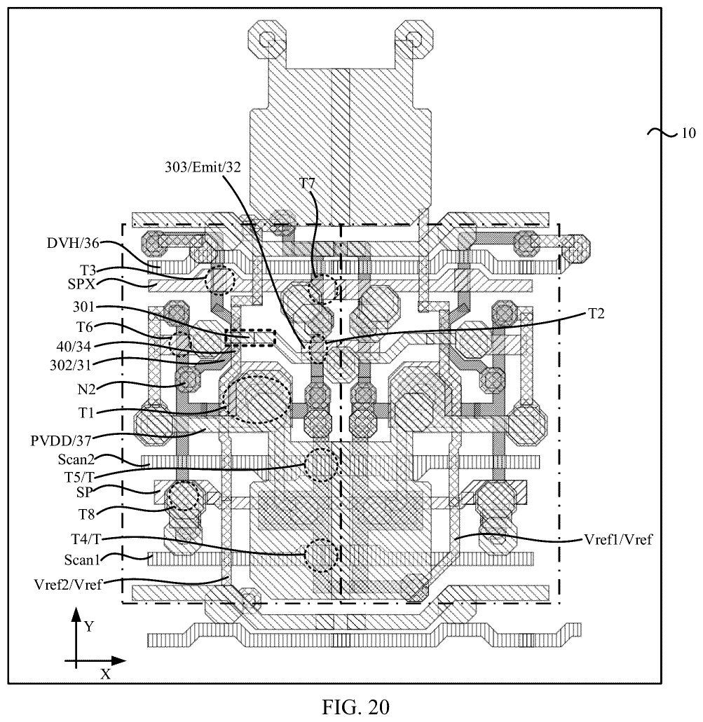

For example, FIG. 20 is another schematic diagram of a partial film layer structure of the pixel driver circuit shown in FIG. 7. Referring to FIG. 7 and FIG. 20, two adjacent pixel driver circuits 30 in the first direction X share a same first connection line 301.

For example, the third connection line 303 may be located in the first metal layer 32. In a same pixel driver circuit 30, in the direction (namely the Z direction) perpendicular to the plane of the substrate 10, an overlapping region where the third connection line 303 overlaps with the first semiconductor layer 31 forms a channel region of the light-emitting control transistor T2. As the gate of the light-emitting control transistor T2, the third connection line 303 may be electrically connected to the first connection line 301 through a through-hole.

Further, two adjacent pixel driver circuits 30 in the first direction X share a same first connection line 301. This can simplify the line layout and reduce the process difficulty.

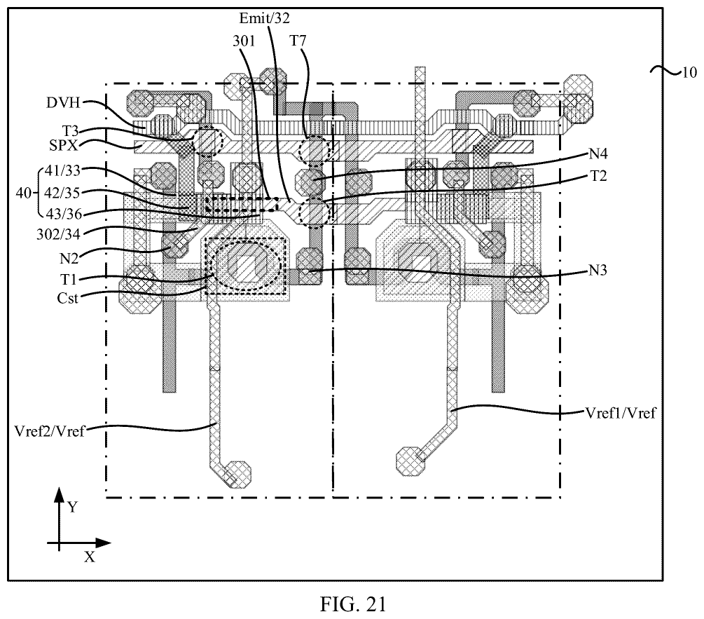

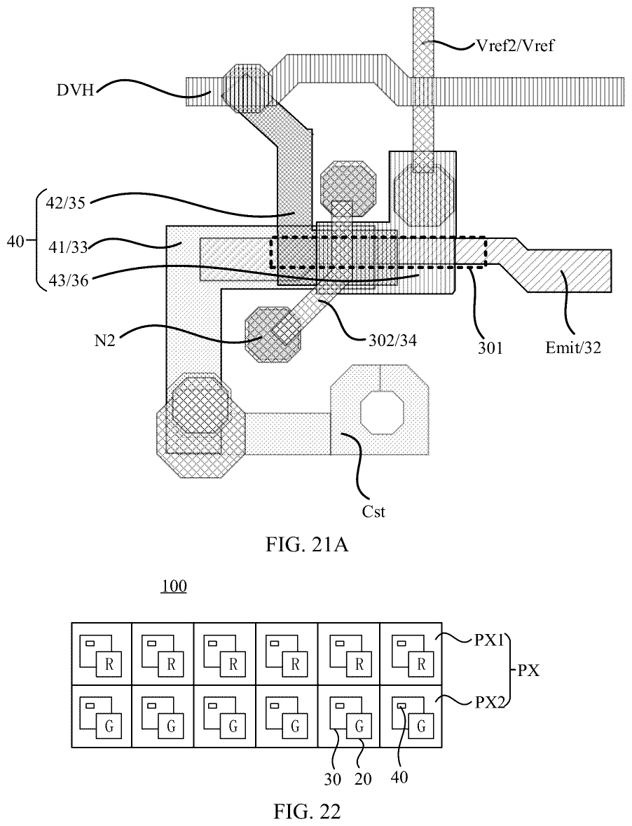

For example, FIG. 21 is another partial schematic diagram of a partial film layer structure of the pixel driver circuit shown in FIG. 7. With reference to FIG. 7 and FIG. 20, the pixel driver circuit 30 further includes a storage capacitor Cst. The storage capacitor Cst includes a first plate and a second plate. The first plate is reused as the gate of the drive transistor T1. In the direction (namely the Z direction) perpendicular to the plane of the substrate 10, the first plate is located between the substrate 10 and the second plate. The display panel 100 further includes an adjustment signal line DVH, a reset signal line Vref, and a reset transistor T. The adjustment signal line DVH is electrically connected to the second electrode of the transmission transistor T3. The reset transistor T includes a first electrode electrically connected to the gate of the drive transistor T1 or the first electrode portion 21, and a second electrode electrically connected to the reset signal line Vref.

Referring to FIG. 7, the reset signal line Vref may include a first reset signal line Vref1 and a second reset signal line Vref2. The reset transistor T in the pixel driver circuit 30 may be the first reset transistor T4 or the second reset transistor T7. Details are not described herein again.

FIG. 21A is a partially enlarged schematic diagram of a partial film layer structure in FIG. 21. Referring to FIG. 21 and FIG. 21A, the shielding component 40 includes at least two of a first shielding element 41, a second shielding element 42, and a third shielding element 43. The first shielding element 41 is electrically connected to the second plate of the storage capacitor Cst. The second shielding element 42 is electrically connected to the adjustment signal line DVH. The third shielding element 43 is electrically connected to the reset signal line Vref. It should be noted that the first shielding element 41, the second shielding element 42, and the third shielding element 43 are located in different film layers, such that when the shielding component 40 includes at least two of the first shielding element 41, the second shielding element 42, and the third shielding element 43, no short circuit occurs between the different shielding elements.

For example, FIG. 21 shows that the shielding component 40 may include the first shielding element 41, the second shielding element 42, and the third shielding element 43. The first shielding element 41 may be located in the second metal layer 33, the second shielding element 42 may be located in the second semiconductor layer 35, and the third shielding element 43 may be located in the fourth metal layer 36, but not limited thereto. Referring to FIG. 21, the first connection line 301 may be located in the first metal layer 32. The second connection line 302 may be located in the third metal layer 34. In the direction (namely the Z direction) perpendicular to the plane of the substrate 10, the first shielding element 41, the second shielding element 42, and the third shielding element 43 are located between the first connection line 301 and the second connection line 302. The first shielding element 41, the second shielding element 42, and the third shielding element 43 are electrically connected to different signal lines, to be configured to receive different DC voltage signals, to further prevent the light-emitting control scanning signal on the light-emitting control scanning signal line Emit from having coupling impact on the potential of the first electrode of the drive transistor T1. This resolves a problem in the related art that the display panel is not black in a black state when the pixel driver circuit 30 works in a low-frequency mode to drive the light-emitting element 20 to perform black-state display, and improves display uniformity, to improve the display quality of the display panel 100.

It should be noted that a line layout and positions of connection through-holes for the first shielding element 41, the second shielding element 42, and the third shielding element 43 connected to the corresponding signal lines can be adaptively adjusted based on an actual situation. FIG. 21 merely shows an example.

For example, FIG. 22 is a partial schematic diagram of a structure of a display panel according to an embodiment of the present disclosure. As shown in FIG. 22, the display panel 100 includes a plurality of pixel sub-regions PX. The plurality of pixel sub-regions PX include a first pixel sub-region PX1 and a second pixel sub-region PX2. A plurality of light-emitting elements 20 include a red light-emitting element R and a green light-emitting element G. The red light-emitting element R is electrically connected to the pixel driver circuit 30 located in the first pixel sub-region PX1. The green light-emitting element G is electrically connected to the pixel driver circuit 30 located in the second pixel sub-region PX2. The first pixel sub-region PX1 and/or the second pixel sub-region PX2 include the shielding component 40.

An arrangement of the first pixel sub-region PX1 and the second pixel sub-region PX2 may be arbitrarily configured, and is not limited herein. FIG. 22 merely shows an example, but not limited thereto.

For example, the pixel driver circuit 30 in the first pixel sub-region PX1 is configured to drive the red light-emitting element R to emit red light, and the pixel driver circuit 30 in the second pixel sub-region PX2 is configured to drive the green light-emitting element R to emit green light. Considering that sensitivity of human eyes to green light and red light is higher than that to blue light, the shielding component 40 may be disposed in the pixel driver circuits 30 in the first pixel sub-region PX1 and/or the second pixel sub-region PX2 to ensure that the light-emitting element 20 can stably emit light, to improve the display quality of the display panel 100. For example, FIG. 22 shows that the shielding component 40 may be disposed in the pixel driver circuits 30 in the first pixel sub-region PX1 and/or the second pixel sub-region PX2, but not limited thereto.

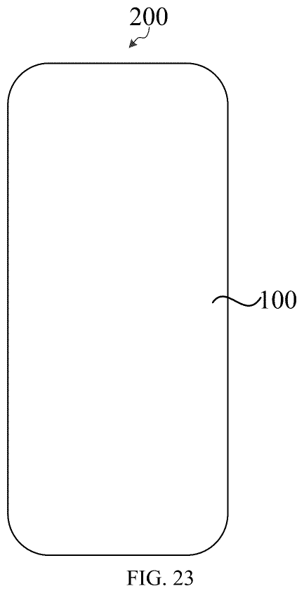

Based on a same inventive concept, the embodiments of the present disclosure further provide a display device. FIG. 23 is a structural schematic diagram of a display device according to an embodiment of the present disclosure. As shown in FIG. 23, the display device 200 includes the display panel 100 according to any embodiment of the present disclosure. The display device 200 provided in the embodiments of the present disclosure may be a mobile phone or any electronic product having a display function, including but not limited to a television, a notebook computer, a desktop display, a tablet computer, a digital camera, a smart band, smart glasses, a vehicle-mounted display, a medical device, an industrial control device, and a touch interactive terminal. This is not particularly limited in the embodiments of the present disclosure.

It should be noted that the foregoing description merely describes preferred embodiments of the present disclosure and the technical principle in use. Those skilled in the art can understand that the present disclosure is not limited to the embodiments described herein, and various obvious changes, adjustments, combinations, and substitutions can be made by those skilled in the art, without departing from a scope of the present disclosure. Therefore, although the present disclosure has been described in detail by using the foregoing embodiments, the present disclosure is not limited to the foregoing embodiments, but can also include more other equivalent embodiments without departing from a concept of the present disclosure, and the scope of the present disclosure is determined by the scope of the appended claims.

What is claimed is:

1. A display panel, comprising:
a substrate;
a light-emitting element comprising a first electrode portion, a light-emitting layer, and a second electrode portion;
a pixel driver circuit located at a side of the substrate and comprising a drive transistor, a light-emitting control transistor, and a transmission transistor;
a light-emitting control scanning signal line extending in a first direction, connected to a gate of the light-emitting control transistor, and comprising a first connection line;
a second connection line comprising a first end electrically connected to a first electrode of the drive transistor and a second end electrically connected to a first electrode of the transmission transistor, wherein the light-emitting control transistor comprises a first electrode electrically connected to a second electrode of the drive transistor and a second electrode electrically connected to the first electrode portion of the light-emitting element; and
a shielding component configured to receive a direct current voltage signal, wherein in a direction perpendicular to a plane of the substrate, the shielding component is located between the first connection line and the second connection line, and the shielding component, the first connection line, and the second connection line overlap with each other.

2. The display panel according to claim 1,
wherein the pixel driver circuit further comprises a storage capacitor, the storage capacitor comprises a first plate and a second plate, and the first plate is reused as a gate of the drive transistor; and in the direction perpendicular to the plane of the substrate, the first plate is located between the substrate and the second plate; and
wherein the shielding component comprises a first shielding element electrically connected to the second plate.

3. The display panel according to claim 2, wherein the first shielding element is configured to receive a first supply voltage, and the second electrode portion is configured to receive a second supply voltage lower than the first supply voltage.

4. The display panel according to claim 2, wherein the transmission transistor is a data writing transistor configured to write a data signal into the gate of the drive transistor; or the transmission transistor is a bias adjustment transistor configured to write a bias adjustment voltage into the first electrode of the drive transistor.

5. The display panel according to claim 2, wherein the first shielding element is disposed in a same layer as the second plate.

6. The display panel according to claim 2,
wherein the first shielding element comprises a first shielding sub-element, and in the direction perpendicular to the plane of the substrate, the first shielding sub-element overlaps with the first connection line and the second connection line; and
wherein a width of the first shielding sub-element in a second direction is greater than a width of the first connection line in the second direction intersecting the first direction.

7. The display panel according to claim 2,
wherein the pixel driver circuit further comprises a first reset transistor, the first reset transistor comprises a first electrode electrically connected to the first plate, an oxide semiconductor channel, and a top gate; and a film layer of the oxide semiconductor channel is located between a film layer of the second plate and a film layer of the top gate in the direction perpendicular to the plane of the substrate; and
wherein the first shielding element is disposed in a same layer as the top gate.

8. The display panel according to claim 7,
wherein the first shielding element comprises a first shielding sub-element and a second shielding sub-element, and in the direction perpendicular to the plane of the substrate, the first shielding sub-element overlaps with the first connection line and the second connection line; and
wherein the second shielding sub-element is disposed in a same layer as the first shielding sub-element and is electrically connected to the first shielding sub-element, and the second shielding sub-element overlaps with the second connection line in the direction perpendicular to the plane of the substrate.

9. The display panel according to claim 1, further comprising an adjustment signal line electrically connected to a second electrode of the transmission transistor, wherein the shielding component comprises a second shielding element electrically connected to the adjustment signal line.

10. The display panel according to claim 9, wherein the adjustment signal line is configured to transmit a bias adjustment voltage; and the transmission transistor is a bias adjustment transistor configured to write the bias adjustment voltage into the first electrode of the drive transistor.

11. The display panel according to claim 9, wherein the second shielding element is disposed in a same layer as the adjustment signal line.

12. The display panel according to claim 11, wherein a plurality of pixel driver circuits arranged in the first direction share a same second shielding element.

13. The display panel according to claim 12,
wherein the adjustment signal line extends in the first direction; and
wherein the display panel further comprises an auxiliary adjustment signal line extending in a second direction intersecting the first direction, and the auxiliary adjustment signal line is electrically connected to at least one of the adjustment signal line or the second shielding element by a through-hole.

14. The display panel according to claim 9, wherein the second shielding element is reused as the adjustment signal line.

15. The display panel according to claim 1, further comprising a reset signal line and a reset transistor,
wherein the reset transistor comprises a first electrode electrically connected to a gate of the drive transistor or the first electrode portion of the light-emitting element, and a second electrode electrically connected to the reset signal line; and
wherein the shielding component comprises a third shielding element electrically connected to the reset signal line.

16. The display panel according to claim 15,
wherein a plurality of reset transistors are provided and comprise a first reset transistor and a second reset transistor, and a plurality of reset signal lines are provided and comprise a first reset signal line and a second reset signal line;
wherein the first reset transistor comprises a first electrode electrically connected to the gate of the drive transistor and a second electrode electrically connected to the first reset signal line, and the second reset transistor comprises a first electrode electrically connected to the first electrode portion of the light-emitting element and a second electrode electrically connected to the second reset signal line; and
wherein the third shielding element is electrically connected to at least one of the first reset signal line or the second reset signal line.

17. The display panel according to claim 15,
wherein the transmission transistor is a bias adjustment transistor configured to write a bias adjustment voltage into the first electrode of the drive transistor; and
wherein the reset signal line is configured to transmit a reset voltage.

18. The display panel according to claim 15, wherein the second connection line is disposed in a same layer as the reset signal line.

19. The display panel according to claim 18, comprising a plurality of pixel sub-regions, wherein the reset signal line extends in a second direction intersecting the first direction, wherein in a same pixel sub-region, in the first direction, an orthographic projection of the second connection line onto the substrate and an orthographic projection of a channel of the drive transistor onto the substrate are respectively located at two sides of an orthographic projection of the reset signal line onto the substrate.

20. A display device, comprising a display panel comprising:
a substrate;
a light-emitting element comprising a first electrode portion, a light-emitting layer, and a second electrode portion;
a pixel driver circuit located at a side of the substrate and comprising a drive transistor, a light-emitting control transistor, and a transmission transistor;
a light-emitting control scanning signal line extending in a first direction, connected to a gate of the light-emitting control transistor, and comprising a first connection line;
a second connection line comprising a first end electrically connected to a first electrode of the drive transistor and a second end electrically connected to a first electrode of the transmission transistor, wherein the light-emitting control transistor comprises a first electrode electrically connected to a second electrode of the drive transistor and a second electrode electrically connected to the first electrode portion of the light-emitting element; and
a shielding component configured to receive a direct current voltage signal, wherein in a direction perpendicular to a plane of the substrate, the shielding component is located between the first connection line and the second connection line, and the shielding component, the first connection line, and the second connection line overlap with each other.
